(19) United States
(12) Patent Application Publication
(10) Pub. No.: US 2003/0098798 A1
(43) Pub. Date: May 29, 2003

(54) Manufacturing system, and apparatus and system for administering the manufacturing system

(75) Inventor: Mitsuaki Kato, Anjo-shi (JP)

Correspondence Address: OLIFF & BERRIDGE, PLC, P.O. BOX 19928, ALEXANDRIA, VA, 22320, US

(73) Assignee: Fuji Machine Mfg. Co., Ltd., Chiryu-shi (JP)

(21) Appl. No.: 10/253,664

(22) Filed: Sep. 25, 2002

(30) Foreign Application Priority Data
Sep. 28, 2001 (JP) 2001-302630

(51) Int. Cl. G08B 21/00

(52) U.S. Cl. 340/679

(57) ABSTRACT

A manufacturing system wherein a host computer is provided with a WWW server through which an operating efficiency and a status of working devices of the system are delivered through a LAN or an internet using HTTP, to a production manager and equipment supplier personnel, and an electronic-mail transmitting program for transmitting an electronic mail to a cellular phone of an operator, to provide the operator with necessary information, such as depletion of electronic components in an electronic-component mounting device, or stopping of the manufacturing system due to an error.

### BACKGROUND OF THE INVENTION

1. Field of the Invention

The present invention relates to techniques for informing an external device of operating states of working devices belonging to a manufacturing system, and for permitting the external device to easily investigate the operating states of the working devices.

2. Discussion of Related Art

A manufacturing system such as a printed-wiring-board working system arranged to mount electric components (including electronic components) on a printed-wiring-board to fabricate printed-circuit boards usually includes a plurality of working devices. In this type of manufacturing system, the working devices are assigned to perform respective working operations. In the recent years, most of these working devices are automatically controlled, and the operator of the working system is merely required to take an appropriate procedure when the operator is informed by a visual indication by a display device or an optical indication by a signal tower that the procedure is necessary, upon stopping of any working device due to any error, for instance. For the operator to take the appropriate procedure in such a case, the operator is required to stay at a location at which the operator is able to visually recognize the visible indication provided on the display device or the optical indication provided by the signal tower.

Further, an administrator in charge of the manufacturing system, for example, a production process manager, who may want to obtain know an operating efficiency or other information of the system, does not have any means available to obtain the information, other than daily records prepared at the production site where the system is installed, and is therefore required to go to the production site, to obtain the information directly from the manufacturing system when needed. When the manufacturing system suffers from a problem that cannot be dealt with by the operator, the operator may contact by telephone an appropriate engineer in charge of the manufacturing system. In this case, a conversation with the operator may not permit the engineer to understand the details of the state of the manufacturing system, so that the engineer is often required to go to the production site. Similar situations take place where the in-house engineer of a company using the manufacturing system is unable to take the appropriate procedure, and is required to consult an outside engineer such as an engineer of a supplier or maker of the manufacturing system or its working devices.

### SUMMARY OF THE INVENTION

The present invention was made in view of the background situation described above. It is an object of the present invention to enable a person remote from the manufacturing system, to easily recognize states of constituent working devices of the manufacturing system. This object may be achieved according to any one of the following modes of this invention in the form of a manufacturing system or an apparatus or a system for administering the manufacturing system, each of which is numbered like the appended claims and depends from the other mode or modes, where appropriate, for easy understanding of the invention. It is to be understood that the present invention is not limited to the technical features of the following modes or any combinations thereof. It is to be further understood that a plurality of elements or features included in any one of the following modes of the invention are not necessarily provided all together, and that the invention may be embodied with only selected one or ones of the elements or features described with respect to the same mode.

(1) A manufacturing system including at least one working device operable to perform a predetermined working operation on an object, which working operation is at least a portion of a process of manufacturing a desired product, the manufacturing system comprising:

a communication device operable to effect at least one of transmission and reception of information through a public communication network.

(2) A manufacturing system including at least one working device operable to perform a predetermined working operation on an object, which working operation is at least a portion of a process of manufacturing a desired product, the manufacturing system comprising:

a WWW server operable to deliver information relating to the at least one working device.

While the WWW server may be used to deliver information to an external device through a public communication line or network, the use of the public communication network is not essential. Namely, the information may be delivered to the external device through a private communication line or network. The information may be delivered using both the public communication network and the private communication network. The term “external device” is interpreted to mean a device at a location remote from the manufacturing system, and is not limited to a device outside a factory or company having the manufacturing system.

The provision of the WWW server permits information relating to the working device or devices to be available as needed at a remote location at which the working device and the manufacturing system cannot be directly observed. Further, the use of a browser commonly available, that is, the use of an internet browser permits transmission and reception of information to and from the external device, thereby eliminating a need of using an exclusive software.

(3) A manufacturing system including at least one working device operable to perform a predetermined working operation on an object, which working operation is at least a portion of a process of manufacturing a desired product, the manufacturing system comprising:

an electronic-mail transmitting device operable to transmit an electronic mail relating to a state of the at least one working device.

(4) A manufacturing system according to the above mode (1), wherein the communicating device includes an operator-used-information transmitting device operable to transmit, to a portable remote terminal through the public communication network, information for use by an operator of the at least one working device.

The operator-used-information transmitting device may be provided in each of the at least one working device, or in a host computer which is connected to a plurality of working devices of the manufacturing system and which controls the manufacturing system. In the latter case, the information for use by the operator is transmitted from the working device(s) through the host computer and the communication network.

In the manufacturing system according to the above mode (4), information that should be immediately forwarded to the operator, such as information indicating stopping of the manufacturing system due to an error, can be transmitted when needed, to the operator of the appropriate working device.

(5) A manufacturing system according to the above mode (4), wherein the information for use by the operator includes error-stop information informing the operator that the working device has been turned off due to an error.

In a conventional manufacturing system, the operator is provided with the error-stop information, by a visual indication provided on a display device of the working device, or an optical indication by a signal tower of the working device, so that the operator is required to always attend the working device at a location where the operator can make visual inspection of the display device or signal tower. In the manufacturing system according to the above mode (5), the information indicating that the working device has been turned off due to an error can be transmitted to a portable remote terminal carried by the operator, so that the operator may stay at a position distant from the working device.

(6) A manufacturing system according to the above mode (4) or (5), wherein the at least one working device includes an electronic-component mounting device operable to mount electronic components on a printed substrate, and the information for use by the operator includes component-depletion information informing the operator that the electronic-component mounting device has been depleted or is expected to be depleted in the near future, of the electronic components of at least one kind.

(7) A manufacturing system according to any one of the above modes (1) and (4)-(6), wherein the communicating device includes an administrator-used-information transmitting device operable to transmit, to a terminal computer through the public communication network, information for use by an administrator of the manufacturing system, which information relates to the working operation of the at least one working device and includes information relating to an operating efficiency of the working device.

The administrator indicated above includes: in-house administrator within a factory or company having the manufacturing system in question, such as personnel assigned to control or manage production processes of the manufacturing system; and outside administrator such as service engineers and designers of the manufacturing system, who is a person of a supplier or manufacturer of the manufacturing system. Thus, the administrator includes an administrator of the user of the manufacturing system, who is assigned to administrate the operators, the manufacturing system and the production processes, and an administrator of the supplier or manufacturer of the manufacturing system, who is assigned to administer the manufacturing system.

(8) A manufacturing system according to the above mode (7), wherein the working device includes a display device operable to indicate a state thereof, and the information for use by the administrator includes information indicative of contents of display provided on the display device.

The above-indicated state of the working device to be indicated includes, in a narrow sense, stopping of the working device due to an error, depletion of components to be handled by the working device, details of such states, and a progress of the working operation of the working device. In a broad sense, however, the above-indicated state is interpreted to include also a state in which the operator is required or instructed to perform or take a given operation or procedure with respect to the manufacturing system.

(9) A manufacturing system according to any one of the above mode (1) and (4)-(8), wherein the working device includes an information receiving device operable to receive information through the public communication network.

(10) A manufacturing system according to the above mode (9), wherein the working device includes a display device operable to display a state thereof, and the information receiving device includes a view-changing-command receiving portion operable to receive a view-changing command which commands the display device to change a display view provided on the display device.

(11) A manufacturing system according to the above mode (9) or (10), wherein the information receiving device includes a remote-control-signal receiving portion operable to receive a remote control signal for remote control of the working device.

(12) A manufacturing system according to any one of the above modes (1) and (4)-(11), wherein the communication device includes an electronic-mail transmitting and receiving device operable for transmission and reception of an electronic mail to and from an external device through the public communication network.

The electronic-mail transmitting and receiving device is arranged for transmission and reception of information between the manufacturing system and a specific external device. The meaning of the term “external device” has been described above with respect to the above mode (2).

(13) A manufacturing system according to any one of the above modes (1) and (4)-(12), wherein the communication device includes a WWW-information transmitting and receiving device operable for transmission and reception of a WWW information to and from an external device through the public communication network.

The WWW-information transmitting and receiving device is capable of transmitting information to multiple and unspecified receivers, and receiving information from an external device which is transmitting information to multiple and unspecified receivers. The WWW-information includes at least one of character information, voice information, static-image or still-picture information, and dynamic-image information. The meaning of the term “external device” has been described above with respect to the above mode (2).

(14) A manufacturing system according to any one of the above modes (1)-(13), wherein the working device is a circuit-substrate working device operable to perform a predetermined operation on a printed substrate, and the manufacturing system is a printed-circuit-board manufacturing system operable to perform at least a portion of a process of manufacturing a printed-circuit board.

(15) An administering system for administering a manufacturing system, at a location remote from the manufacturing system, the manufacturing system including at least one working device operable to perform a predetermined working operation on an object, which working operation is at least a portion of a process of manufacturing a desired product, the administering system comprising:

(a) a display device and (b) a communication device which are provided in the manufacturing system, the display device being operable to provide a display view indicating at least a state of the working device, the communication device being connected to the display device and provided with a display-information transmitting portion operable to transmit display information relating to the display view provided on the display device, the communication device being operable to effect transmission and reception of information through a communication network; and

an administering apparatus disposed at a location remote from the manufacturing system and provided with a communicating portion and a display portion, the communicating portion having a display-information receiving portion operable to receive the display information, and being operable to effect transmission and reception of information through the communication network, the display portion being operable to provide a display view including the display view provided on the display device, on the basis of the display information received.

(16) An administering system according to the above mode (15), wherein the administering apparatus is provided with an operating-information obtaining portion operable to obtain operating information relating to an operation performed on the administering apparatus, and the communicating portion is provided with an operating-information transmitting portion operable to transmit the operating information,

and wherein the communicating device has an operating-information receiving portion operable to receive the operating information, and the display device is provided with an external-information-based operating portion operable to control its display view on the basis of the operating information received.

(17) An administering system according to the above mode (16), wherein the display device provides as the display view an operation control view used to control contents of display provided thereon,

and wherein the operating-information obtaining portion is operable to obtain the operating information relating to an operation on the basis of the display view which is provided on the display portion and which includes the operation control view, the operating information being correlated to the operation control view.

(18) An administering system according to the above mode (17), wherein the display device is provided with an operation-contents indicating portion operable when the display view of the display device is controlled by the external-information-based operating portion, the operation-contents indicating portion indicating, within the display view, contents of an operation performed on the basis of the operating information.

(19) An administering system according to any one of the above modes (15)-(18), wherein the communication device is provided with a WWW server for delivering the display information of the display view provided on the display device, and the administering apparatus is provided with a browser for browsing the display information to be delivered by the WWW server.

(20) A manufacturing system including at least one working device operable to perform a predetermined working operation on an object, which working operation is at least a portion of a process of manufacturing a desired product, the manufacturing system being administered by an administering apparatus existing at a location remote from the manufacturing system, and comprising:

a display device operable to provide a display view indicating at least a state of the working device; and

a communication device connected to the display device and provided with a display-information transmitting portion operable to transmit to the administering apparatus display information relating to the display view provided on the display device, such that a display view provided by the administering apparatus can include the display view provided on the display device.

(21) A manufacturing system according to the above mode (20), wherein the communication device has an operating-information receiving portion operable to receive operating information relating to an operation performed on the administering apparatus to cause the administering apparatus to control the display view provided on the display device, and the display device is provided with an external-information-based operating portion operable to control its display view on the basis of the operating information received.

(22) A manufacturing system according to the above mode (21), wherein the display device provides as the display view an operation control view used to control contents of display provided thereon,

and wherein the operating information is correlated to the operation control view.

(23) A manufacturing system according to the above mode (22), wherein the display device is provided with an operation-contents indicating portion operable when the display view of the display device is controlled by the external-information-based operating portion, the operation-contents indicating portion indicating, within the display view, contents of an operation performed on the basis of the operating information.

(24) A manufacturing system according to any one of the above modes (20)-(23), wherein the communication device is provided with a WWW server for delivering the display information of the display view provided on the display device.

(25) An administering apparatus for administering a manufacturing system, at a location remote from the manufacturing system, the manufacturing system including at least one working device operable to perform a predetermined working operation on an object, which working operation is at least a portion of a process of manufacturing a desired product, the manufacturing system further including a display device operable to provide a display view indicating at least a state of the working device, the administering apparatus comprising:

a communicating portion having a display-information receiving portion operable to receive display information relating to the display view provided on the display device, the communicating portion being operable to effect transmission and reception of information through a communication network; and

a display portion operable to provide a display view including the display view provided on the display device, on the basis of the display information received.

(26) An administering apparatus according to the above mode (25), further comprising an operating-information obtaining portion operable to obtain operating information relating to an operation performed on the administering apparatus, and the communicating portion is provided with an operating-information transmitting portion operable to transmit the operating information.

(27) An administering apparatus according to the above mode (26), wherein the display device provides as the display view an operation control view used to control contents of display provided thereon,

and wherein the operating-information obtaining portion is operable to obtain the operating information relating to an operation on the basis of the display view which is provided on the display portion and which includes the operation control view, the operating information being correlated to the operation control view.

(28) An administering apparatus according to the above mode (27), wherein the operating information includes operation-contents information indicating contents of an operation of the administering apparatus to control the display view of the display device when the display view of the display device is controlled by the administering apparatus.

(29) An administering apparatus according to any one of the above modes (25)-(28), wherein the display information of the display view provided by the display device is delivered by a WWW server, the administering apparatus further comprising a WWW browser for browsing the display information to be delivered by the WWW server.

The above-indicated moves (15) through (29) of the present invention are suitable for administering the manufacturing system at a location remote from the manufacturing system. In these modes, the display view provided on the display device of the manufacturing system and the display view provided on the display portion of the administering apparatus are correlated with each other. According to the above modes (15)-(19), there are provided administering systems including the manufacturing system and the administering apparatus for administering the manufacturing system. According to the above modes (20)-(24), there are provided manufacturing systems to be administered by an administering apparatus. According to the above modes (25)-(29), there are provided administering apparatuses for administering the manufacturing system.

According to the above modes (15), (20) and (25), the contents of the display view provided on the display device such as a display on an operator's control panel of each working device can be observed at the administering apparatus, so that the administrator at a location remote from the manufacturing system can easily grasp the state of each working device. According to the above modes (16), (21) and (26), an operation to change or otherwise control the display view provided on each working device can be performed on the side of the manufacturing system on the side of the administering apparatus, at a location remote from the manufacturing system, for example, so that the state of each working device can be easily grasped. In this instance, the above modes (17), (22) and (27) enable the administrator to manipulate each display device provided in the manufacturing system, on the basis of the display view of that display device on the side of the manufacturing system, which is included in the display view provided on the side of the administering apparatus. Thus, the state of each working device can be grasped more easily. In this instance, the contents of the operation on the side of the administering apparatus can be confirmed on the side of the manufacturing system, according to the above modes (18), (23) and (24).

In the modes (15) through (29), the manufacturing system and the administering apparatus are connected to each other through the communication line or network. The type of this communication network is not particularly limited. Namely, the communication line may be a wire circuit or a wireless circuit, and may be a private exclusive network or a public network. In the case of a remote administration, for example, where the administrator is a manufacturer of the manufacturing system, the administering apparatus may be readily connected to the manufacturing system through a public communication network. Where the public communication network is used, the manufacturing system and the administering apparatus may be communicated with each other either directly or through an internet. Where the manufacturing system is provided with a WWW server while the administering apparatus is provided with a browser, as in the modes (19), (24) and (29), the display information can be easily browsed according to an existing protocol.

According to the above modes (15) through (29), the display view provided in the administering apparatus includes the display view provided on the display device on the side of the manufacturing system. The former display view may include either a whole or only a part of the display view provided on the display device. The term “location remote” is interpreted to mean a location distant from the manufacturing system, and is not limited to a location outside a factory or company having the manufacturing system, as described above with respect to the term “external device” in connection with the above mode (1). The above modes (15) through (29) are advantageous where these modes incorporate the technical feature according to the above mode (14) wherein the working device is a circuit-substrate working device operable to perform a predetermined operation on a printed substrate, and the manufacturing system is a printed-circuit-board manufacturing system operable to perform at least a portion of a process of manufacturing a printed-circuit board.

### BRIEF DESCRIPTION OF THE DRAWINGS

FIG. 1 is a block diagram showing a printed-wiring-board fabricating system according to one embodiment of this invention;

FIG. 2 is a front elevational view showing a mask printing device of the above-indicated system;

FIG. 3 is a plan view of the above-indicated mask printing device;

FIG. 4 is a side elevational view of the above-indicated mask printing device;

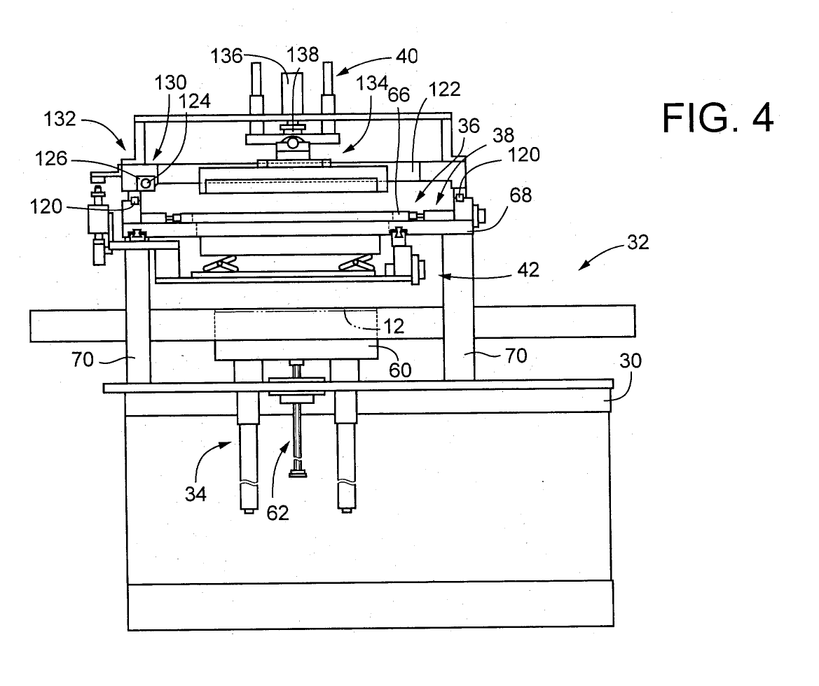

FIG. 5 is a block diagram for explaining a control device of the above-indicated mask printing device;

FIG. 6 is a plan view showing a high-speed electronic-component mounting device of the above-indicated system;

FIG. 7 is a side elevational view in cross section showing in enlargement a portion of the above-indicated high-speed electronic-component mounting device;

FIG. 8 is a block diagram for explaining a control device of the above-indicated high-speed electronic-component mounting device;

FIG. 9 is a flan view showing a multi-purpose electronic-component mounting device of the above-indicated system;

FIG. 10 is a block diagram showing a control device of the above-indicated multi-purpose electronic-component mounting device;

FIG. 11 is a plan view showing an inspecting device of the above-indicated system;

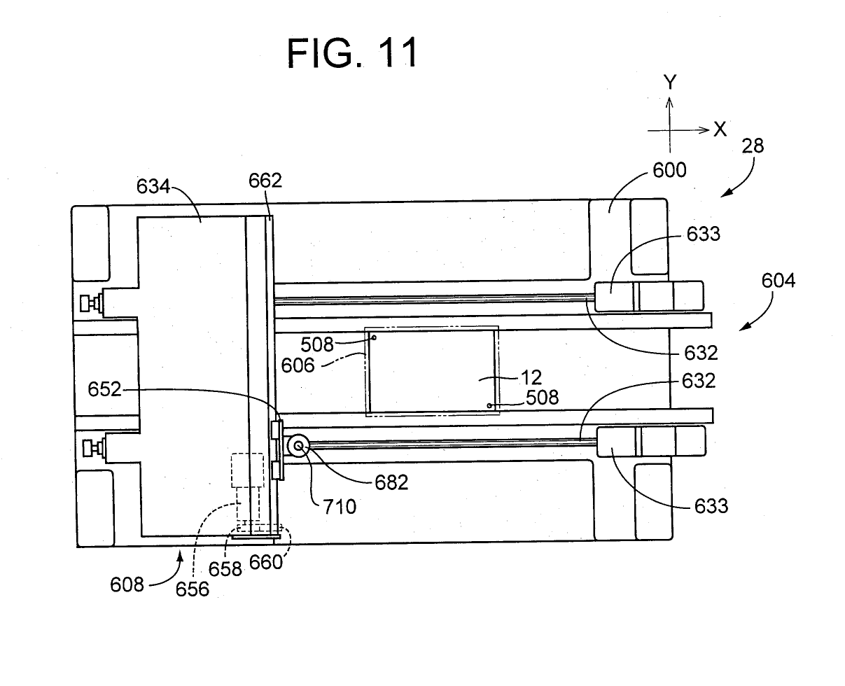

FIG. 12 is a plan view showing a control device of the above-indicated inspecting device;

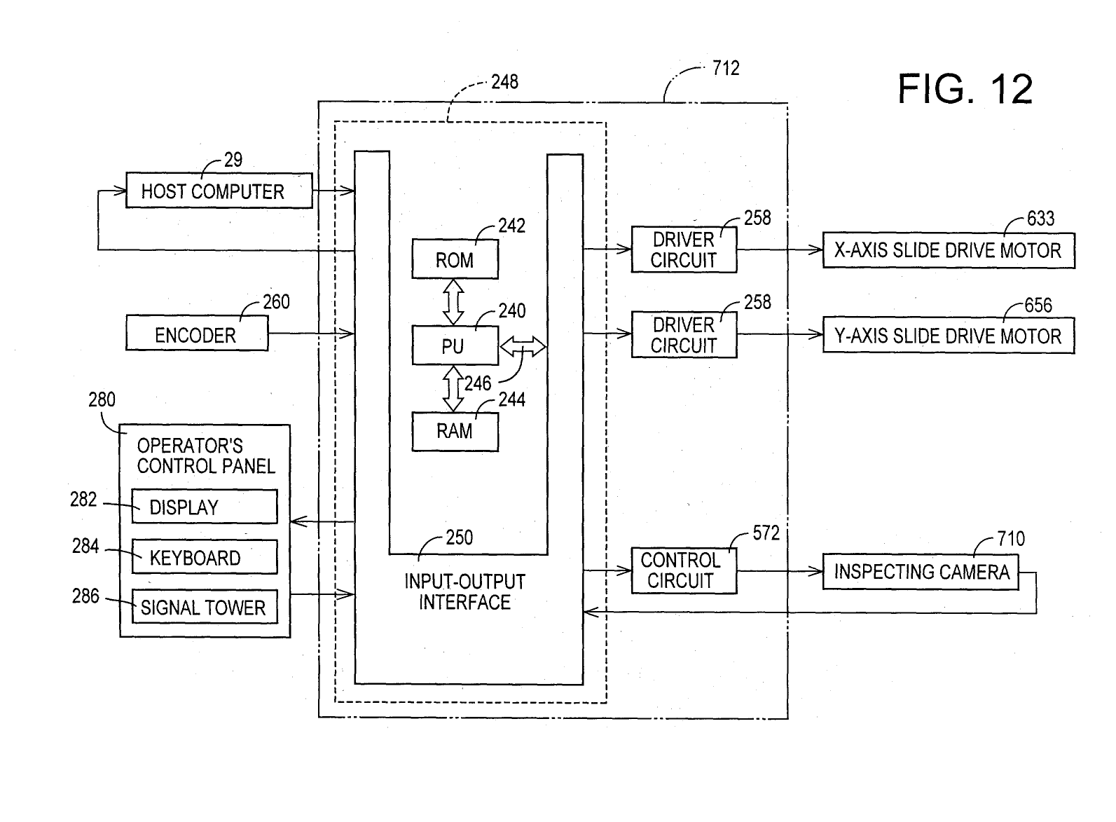

FIG. 13 is a hardware block diagram showing a hardware of a host computer of the above-indicated system;

FIG. 14 is a functional block diagram for explaining a function of the above-indicated host computer;

FIG. 15 is a functional block diagram for explaining another function of the above-indicated host computer;

FIG. 16 is a view illustrating an example of a view displayed on a display of one of the above-indicated control devices;

FIG. 17 is a block diagram showing a printed-wiring-board fabricating system according to another embodiment of this invention;

FIG. 18 is a block diagram for explaining a control device of a mask printing device of the above-indicated system;

FIG. 19 is a functional block diagram for explaining a function of the above-indicated mask printing device;

FIG. 20 is a functional block diagram for explaining another function of the above-indicated mask printing device;

FIG. 21 is a view illustrating a view displayed on a display of an external computer, which corresponds to the view illustrated in FIG. 16;

FIG. 22 is a view illustrating another example of the view displayed on one of the above-indicated control devices;

FIG. 23 is a view illustrating a view displayed on the external computer, which corresponds to the view illustrated in FIG. 22; and

FIG. 24 is a view schematically showing functions of a manufacturing system and a control apparatus principally constituted by the external computer, in relation to the displays and operations to control the displays.

### DETAILED DESCRIPTION OF THE PREFERRED EMBODIMENTS

There will be described in detail a printed-wiring-board working system according to one embodiment of the present invention.

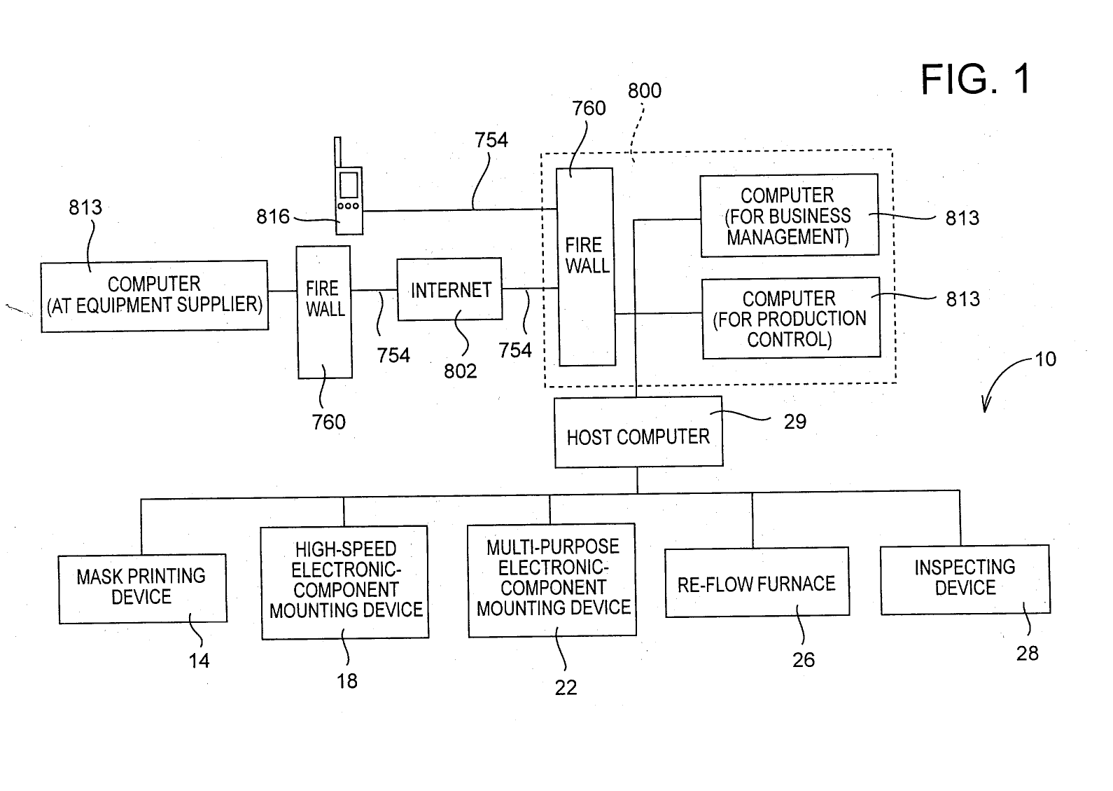

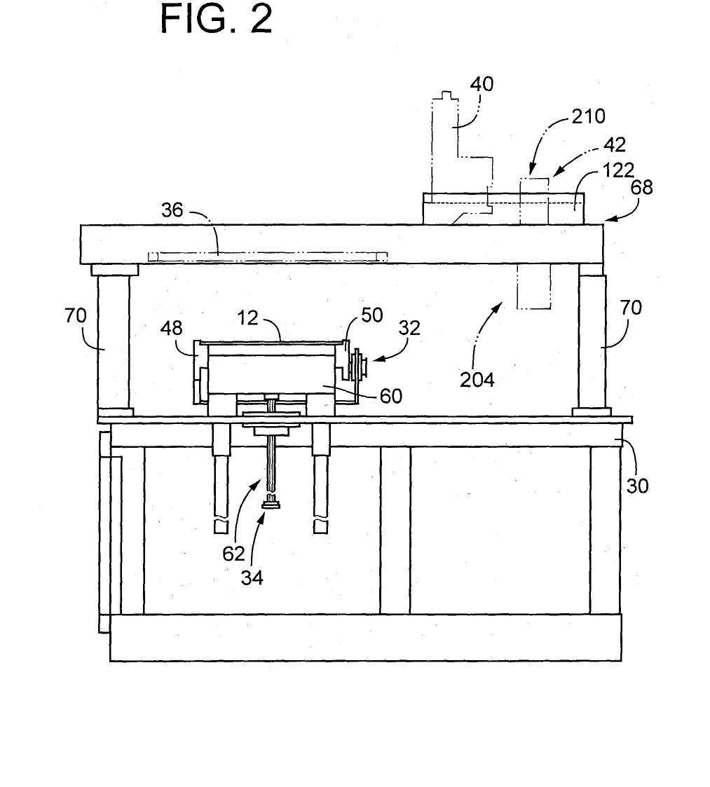

As shown in FIG. 1, the present system 10 includes (a) a mask printing device 14 for applying a solder paste or cream by printing to a circuit substrate in the form of a printed-wiring board 12 (which is shown FIG. 2, and collectively refers to a printed substrate on which electronic components have not been mounted, and a printed-circuit board on which the electronic components have been mounted), (b) a high-speed electronic-component mounting device 18 for mounting primarily the electronic components of comparatively small sizes, and (c) a multi-purpose electronic-mounting device for mounting primarily the electronic components of comparatively large sizes or uncommon shapes. These devices are arranged in the order of description from the upstream side of the system 10 (from the left-hand side of FIG. 1). Between the adjacent ones of the working devices in the present system 10, there is provided a printed-wiring-board conveyor device for conveying the printed-wiring board 12, so that the printed-wiring board 12 is fed from each device to the next downstream device each time a working operation of each device is completed. On the downstream side of the multi-purpose electronic-component mounting device 22, there is disposed a re-flow furnace 26 for finally fixing the electronic components which have been provisionally fixed. On the downstream side of the re-flow furnace 26, there is further disposed an inspecting device 28 for detecting a result of mounting of the electronic components on the board 12. In the present system 10, a common host computer 29 is connected to each of the above-indicated devices. These devices will be described one after another.

To begin with, the mask printing device 14 will be discussed. The present mask printing device 14 is substantially identical with a mask printing device as disclosed in JP-A-2001-116528.

In FIG. 2, reference sign 30 denotes a machine base on which there are mounted: a printed-wiring-board conveyor 32 serving as a transferring device for transferring the printed-wiring board 12; a printed-wiring-board supporting and elevating/lowering device 34 serving as an object supporting device in the form of an object supporting and elevating/lowering device for supporting, elevating and lowering the printed-wiring board 12 transferred by the printed-wiring-board conveyor 32; a printed-wiring-board clamping device (not shown) for clamping the printed-wiring board 12 supported by the printed-wiring-board supporting and elevating/lowering device 34; a mask positioning and holding device 38 for supporting a mask plate 36; a printing device 40 for printing a printing material in the form of a solder paste on the printed-wiring board 12; and a mask cleaning device 42 for cleaning a mask of the mask plate 36.

The printed-wiring-board conveyor 32 has a pair of rails 48, 50, as shown in FIG. 2. An endless belt (not shown) is wound on each of these rails 48, 50, so as to extend in the longitudinal direction of the rails, and the printed-wiring board 12 is placed on these endless belts and is transferred by rotation of the endless belts by a belt drive device not shown. The distance between the two rails 48, 50 is adjustable according to the size of the printed-wiring board 12. The printed-wiring board 12 is located by a stopper device not shown, at a printing position at which the solder paste is printed in the direction of transfer of the printed-wiring board 12.

The printed-wiring-board supporting and elevating/lowering device 34 has an object support table in the form of a printed-wiring-board support table 60 which is disposed below the printing device 40 and which is vertically movable between the pair of rails 48, 50. In the present embodiment, the printed-wiring-board support table 60 is arranged to hold the printed-wiring board 12 by suction under a negative pressure, and support the board 12 in its horizontal attitude. The support table 60 is movable by an elevating and lowering device 62, between a fully lowered position located below the printed-wiring-board conveyor 32, and a fully elevated position in which the printed-wiring board 12 is spaced upwards from the endless belts and is held in contact with a lower surface of the mask of the mask plate 36.

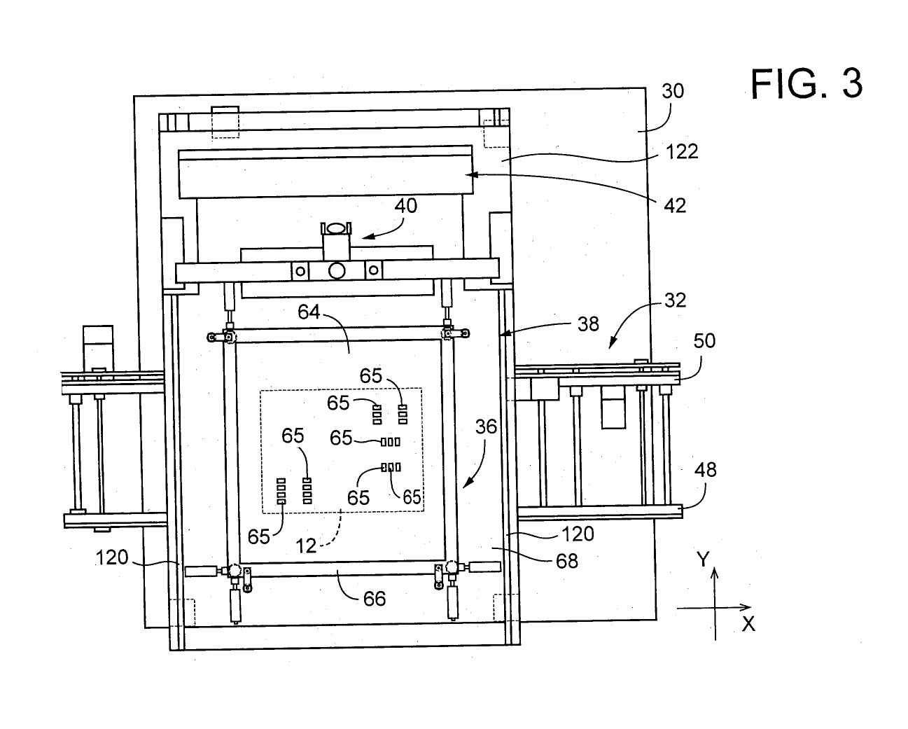

As shown in FIG. 3, the mask plate 36 is provided with a mask frame 66 having a lower surface to which the mask 64 is fixed at its peripheral portion. In the present embodiment, the mask 64 is a stencil mask formed of a nickel alloy, stainless steel or the like. This mask 64 has a plurality of apertures 65 formed through its thickness. In the present embodiment, the apertures 65 have a rectangular shape (which may be a square) in cross section taken in a plane parallel to the mask 64. One flat surface of the printed-wiring board 12 has a plurality of printing spots to be coasted with the solder paste, and the apertures 65 are formed at respective portions of the mask 64 which correspond to the respective printing spots. In the present embodiment, the apertures 65 each having the rectangular cross sectional shape are formed such that one side of the rectangle is parallel to an X-axis direction while the adjacent side of the rectangle is parallel to a Y-axis direction.

Four posts 70 extend upright from the machine base 30, and a mask support table 68 for supporting the mask frame 66 is supported by the four posts 70. The mask plate 36 is supported by the mask support table 68 through the above-indicated mask positioning and holding device 38, such that the horizontal position of the mask plate 36 is adjustable. No further description of the mask positioning and holding device 38 is deemed necessary since it does not directly relate to the present invention.

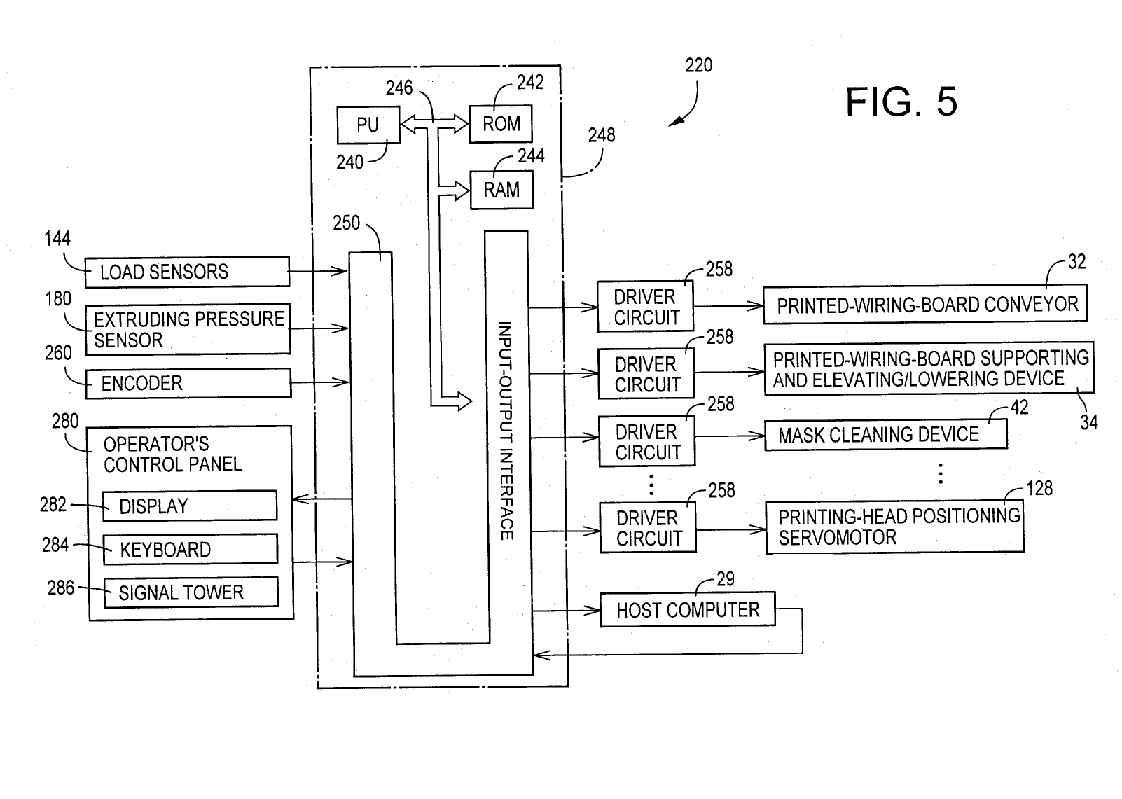

The printing device 40 will be discussed. This printing device 40 is similar in construction to a mask printing device as disclosed in JP-A-9-39214. On the mask support table 68, a slide 122 is disposed movably in a direction perpendicular to the substrate transfer direction or the direction of transfer of the printed-wiring board. The slide 122 is moved by a drive device 130 while being guided by guide rails 120, in the printing direction, that is, in the Y-axis direction perpendicular to the direction of transfer of the printed-wiring board. The drive device 10 includes: a ballscrew 124 supported by the mask support table 68 such that the ballscrew is rotatable and is not axially movable; a nut 126 fixed to the slide 122 and held in engagement with the ballscrew 124; and a printing-head positioning servomotor 128 (shown in FIG. 5). The slide 122 and the drive device 130 constitute a printing-head moving device 132, while the pair of guide rails 120 constitute a guiding device.

A printing head 134 is vertically movable by a printing-head elevating and lowering device in the form of a printing-head elevating and lowering air cylinder 136 mounted on the slide 122. The printing head 134 is mounted on the printing-head elevating and lowering air cylinder 136 through a contact-load adjusting air cylinder 138, load sensors 144 (shown in FIG. 5), etc. The contact-load adjusting air cylinder 138 is controlled on the basis of outputs of the load sensors 144, so that the printing head 134 contacts the mask 64 under a predetermined load.

The printing head 134 is arranged to store the solder paste, and has an outlet which is opposed to the upper surface of the mask 64 and extends in the direction of width of the printing head 134. The solder paste is extruded from the outlet at a predetermined constant pressure. That is, the solder paste is extruded so as to fill the apertures 65 while the printing head 134 is moved on the mask 64, with the outlet held in contact with the upper surface of the mask 64, whereby the solder paste is printed on the printed-wiring board 12. The pressure of extrusion of the solder paste from a solder accommodating chamber of the printing head is monitored by an extruding pressure sensor 180 (shown in FIG. 5).

The printing device 40 is further provided with the mask cleaning device 42 for clearing the mask 64. The mask cleaning device 42, which is similar in construction to a mask cleaning device as disclosed in JP-A-9-39214, does not directly relate to the present invention and will be only briefly described. As shown in FIG. 2, the mask cleaning device 42 includes a cleaner device 204 and a wiping device 210. The cleaner device 204 is disposed on a board-contacting side of the mask 64, that is, disposed below the lower surface of the mask 64 which contacts the printed-wiring board 12. The wiping device 210 is disposed on a solder extruding side of the mask 64, that is, disposed above the upper surface of the mask 64 from which the solder paste is forced into the apertures 65. The mask cleaning device 42 is held by the slide 122 such that the mask cleaning device 42 is not movable in the horizontal direction but is vertically movable. The mask cleaning device 42 is moved relative to the mask 64 in the printing direction, together with the printing device 40.

The present mask printing device 14 is controlled by a control device 220 indicated above. As shown in FIG. 5, the control device 220 is principally constituted by a computer 248 incorporating a PU 240, a ROM 242, a RAM 244, and a bus 246 interconnecting those elements. To the bus 246, there is connected an input-output interface 250 which is connected through driver circuits 358 to the printed-wiring-board conveyor 32, the printed-wiring board supporting and elevating/lowering device 34, the mask cleaning device 42, etc. The input-output interface 250 is also connected to the load sensors 144, extruding pressure sensor 180, encoders 260 for detecting angular positions of the various motors, etc. The input-output interface 250 is further connected to the host computer 29 which controls the present system 10 in a coordinated fashion.

The control device 220 is provided with an operator's control panel 280, which is provided with an indicator device in the form of a display 282, an input device in the form of a keyboard 284, and an alarming device in the form of a signal tower 286, which are connected to the input-output interface 250.

The computer 248 stores various programs such as a main program, for controlling the mask printing device 14, and is arranged to transmit to the host computer 29 information on the operation of the mask printing device 14. The operation of the mask printing device 14 and the information on this operation will be described in detail.

Next, the high-speed electronic-component mounting device 18 will be described.

This high-speed electronic-component mounting device 18, which is arranged to primarily mount electronic components of small sizes, is substantially identical in construction with an electronic-component mounting device as disclosed in Japanese Patent Application No. 2001-172915 filed by the assignee of the present application or the corresponding U.S. patent application Ser. No. 10/159,008.

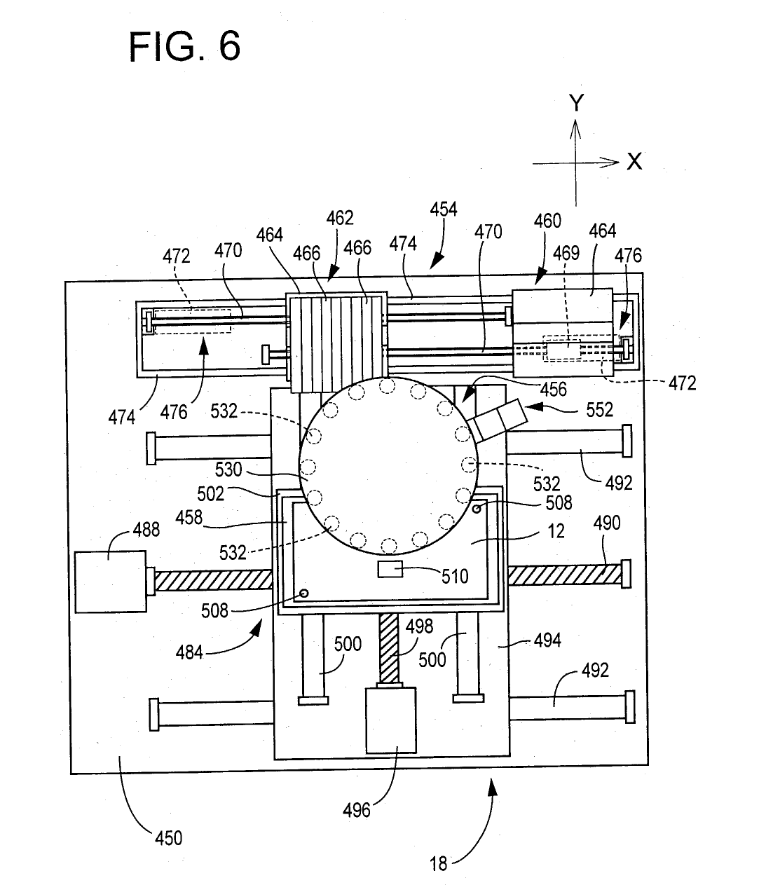

In FIG. 6, reference sign 450 denotes a machine base of the high-speed electronic-component mounting device 18 serving as an electric-component mounting system. On the machine base 450, there are mounted a component-supplying device 454, a component-mounting device 456, and a substrate holding device in the form of a printed-wiring-board holding device 458, which constitute the high-speed electronic-component mounting device 18.

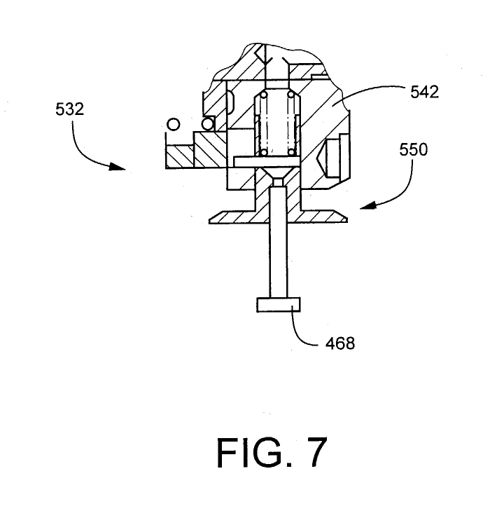

The component-supplying device 454 is provided with at least one component supply table, in this embodiment, two component supply tables 460, 462. Each of these component supply tables 460, 462 has a feeder carriage 464, and a plurality of feeders 466 mounted on the feeder carriage 464. In the present embodiment, each feeder 466 is arranged to feed a carrier tape accommodating electric components in the form of electronic components 468 (shown in FIG. 7), so that the electronic components 468 are supplied from the carrier tape.

The electronic components 468 are accommodated in respective multiple component-accommodating recesses formed in the carrier tape, and the openings of the component-accommodating recesses are closed by a covering tape bonded to the carrier tape. The carrier tape is fed by a tape feeding device (not shown), such that the electronic components 468 are successively fed to a component-supply portion. The plurality of feeders 466 are removably mounted on the feeder carriage 464 such that the component-supply portions of the feeders 466 are arranged along a line, for instance, along a horizontal straight line.

As described below in detail, the high-speed electronic-component mounting device 18 has an XY coordinate system in which movement data for moving the component-supply tables 460, 462, the printed-wiring-board holding device 458, etc. are defined. The component-supply portions of the above-indicated plurality of feeders 466 are arranged in the X-axis direction (left and right direction as seen in FIG. 6) of the XY coordinate system.

The feeder carriage 464 of each of the component-supply tables 460, 462 is provided with a nut 469 fixed thereto, and each component-supply table 460, 462 is moved in the X-axis direction while being guided by a guiding device including a guide rail 474, when a feedscrew in the form of a ballscrew 470 is rotated by a table drive motor 472. Thus, the component-supply portions of the plurality of feeders 466 are selectively moved to a predetermined component-supply position. The ballscrew 470, table drive motor 472, etc. constitute a component-supply-table positioning device 476. Namely, the two component-supply tables 460, 462 are moved independently of each other by the respective two component-supply-table positioning devices 476. It is noted that the guide rail 474 is commonly used for the two component-supply tables 460, 462. Since a manner in which the electronic components 468 are supplied by the two component-supply tables 460, 462 is known as disclosed in JP-B2-8-21791, no further description will be provided. It is noted that FIG. 6 shows the nut 469 of only the component-supply table 460 and the feeders 466 of only the other component-supply table 462, but does not show the feeders 466 of the component-supply table 460 and the nut 469 of the component-supply table 462.

The printed-wiring-board holding device 458 is arranged to hold a circuit substrate in the form of the printed-wiring board 12 in the horizontal attitude, and is movable to a desired position in the XY coordinate system, by a substrate-holding-device positioning device in the form of an XY table 484. The XY table 484 includes an X-axis slide 494 and a Y-axis slide 502 mounted on the X-axis slide 484. The X-axis slide 494 is movable in the X-axis direction while being guided by a guiding device including a guide rail 492, by an X-axis slide drive motor 488 and a feedscrew in the form of a ballscrew 490. The Y-axis slide 502 is movable on the X-axis slide 494 in the Y-axis direction while being guided by a guiding device including guide rails 500, by a Y-axis slide drive motor 496 and a feedscrew in the form of a ballscrew 498.

The printed-wiring-board holding device 458 is disposed on the Y-axis slide 502, and is arranged to support the printed-wiring board 12 in the horizontal attitude in contact with its lower surface. The upper surface of the printed-wiring board 12 has a plurality of component-mounting spots in which the electronic components 468 are to be mounted. These component-mounting spots are sequentially brought to a position corresponding to a predetermined component-mounting position (described below) of the component-mounting device 456, by moving the printed-wiring-board holding device 458.

On the upper surface of the printed-wiring board 12, there are provided a plurality of fiducial marks, in the present embodiment, two fiducial marks 508. When the printed-wiring board 12 is held by the printed-wiring-board holding device 458, images of the fiducial marks 508 are taken by an imaging device in the form of a fiducial-mark camera 510, which is held by a holder member (not shown) provided on a frame of the component-mounting device 456. The fiducial-mark camera 510 is held stationary, so as to face downwards, to take the images of the fiducial marks 508 in the downward direction.

The fiducial-mark camera 510 is provided with a solid image sensor in the form of a matrix of CCDs (charge-coupled devices) and a lens system including focusing lens, and is a surface-imaging device capable of taking a two-dimensional image of an object at one time. The CCDs have respective multiple minute photosensitive elements which are arranged in a plane and which generate electric signals depending upon amounts of incident light. The multiple photosensitive elements define an imaging area or surface. It is noted that an illuminating device (not shown) is provided to illuminate the object and its vicinity when the image of the object is taken by the fiducial-mark camera 510.

The component-mounting device 456 in the present embodiment is similar in construction to an electronic-component mounting device as disclosed in JP-A-6-342998, and an electronic-component mounting device as disclosed in Japanese Patent Application No. 2001-345599 filed by the assignee of the present application or the corresponding U.S. patent application Ser. No. 09/863,431.

As shown in FIG. 6, the component-mounting device 456 is provided with an intermittent rotary body in the form of an indexing body 530, which carries a plurality of component-holding heads 532, in this embodiment, sixteen component-holding heads 532 such that the component-holding heads 532 are equiangularly spaced from each other. When the indexing body 530 is rotated, each component-holding head 532 is sequentially moved to and stopped at sixteen working positions, which are arranged along a circular path of turning movement of each component-holding head 532. The sixteen working positions include: a component-holding position (component-sucking position or component-receiving position); an angular-component-position changing position; a component-hold-position detecting position; a component-hold-position rectifying position; a component-mounting position; an angular-head-position resetting position; a nozzle-holder detecting position; and a nozzle-holder selecting position.

As show in FIG. 7, each component-holding head 532 is provided with a rotary nozzle holder 542 having six nozzle holding portions arranged to hold respective suction nozzles 550. In FIG. 7, only one of the suction nozzles 550 is shown. Each component-holding head 532 is arranged such that a selected one of the suction nozzles 550 is placed in a component-holding position in which the suction nozzle 550 extends downwards and holds the electronic component 468. When the component-holding head 532 has reached the component-receiving position for receiving the electronic component 468 from the component-supplying device 460, 462, a negative pressure is applied to the corresponding suction nozzle 550, so that the electronic component 460 is held by suction by the suction nozzle 550. When the component-holding head 532 has reached the component-mounting position for mounting the electric component 468 on the printed-wiring board 12, the suction nozzle 550 is communicated with a positive pressure source not shown, so that the electronic component 468 is released from the suction nozzle 550. The component-mounting heads 532 are disposed at a vertical position such that during rotation of the indexing body 530 the electronic components 468 do not interference with the printed-wiring board 12. At the component-receiving position and the component-holding position, head elevating and lowering devices are provided for vertically moving the component-holding heads 532 at the component-receiving and component-mounting positions, for permitting the heads 532 to receive and mount the electronic components 468. Further, each component-holding head 532 is supported rotatably about its axis, and is rotated by a head rotating device (not shown) at the component-hold-position rectifying position, etc.

Each of the 16 component-holding heads 532 is provide with an identification code identifying each head 532, and each of the six nozzle holding portions of each component-holding head 532 is provided with an identification code identifying each nozzle holding portion. Further, suction nozzle data indicative of the kind of the suction nozzle 550 held at each nozzle holding portion are stored in relation to each nozzle holding portion. The kind of the suction nozzle 550 placed in its operating position of each component-holding head 532 is specified on the basis of the above-indicated two identification codes and suction nozzle data.

At the above-described component-hold-position detecting position, there are disposed a plurality of, in this embodiment, two sets of component camera, light guiding device and illuminating device, which constitute an imaging device 552. The imaging device 552 provided in this embodiment is similar in construction with a component camera as disclosed in JP-A-5-196441.

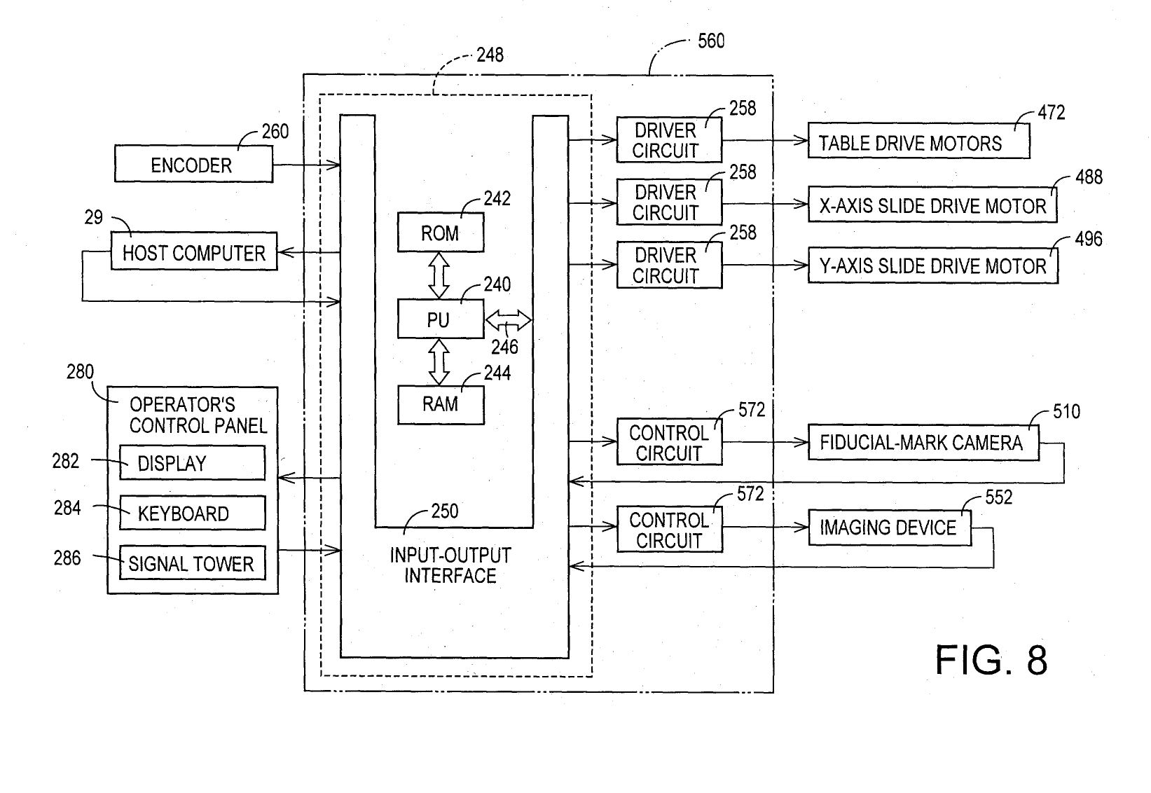

The high-speed electronic-component mounting device 18 constructed as described above is controlled by a control device 560 illustrated in FIG. 8. This control device 560, which is similar in construction to the control device 220 shown in FIG. 5, is principally constituted by the computer 248 incorporating the PU 240, the ROM 242, the RAM 244 and the bus 246 interconnecting these elements. To the bus 246, there is connected the input-output interface 250 to which there are connected the encoders 260 and various other sensors.

To the input-output interface 250, there are also connected through the respective driver circuits 258 various actuators such as the table drive motors 472. The drive motors such as the table drive motors 472, which are provided as drive sources, are electric motors, more specifically, rotary electric motors in the form of servomotors whose operating angles are controllable with high accuracy. However, stepping motors may be used in place of the servomotors. The operating angles of the motors such as the table drive motors 472 are detected by angle detecting devices in the form of the encoders 260, and those motors are controlled on the basis of the outputs of the encoders 260.

To the input-output interface 250, there are also connected through respective control circuits 572 the fiducial-mark camera 510 and the imaging device 552. The driver circuits 258, control circuits 572 and computer 248 constitute the control device 560. The RAM 244 stores various programs and data, such as a program for mounting the electronic components 468 on the printed-wiring board 12.

The present control device 560 is also connected to the host computer 29, and is arranged to transmit to the host computer 29 data obtained by the various sensors, control data for the drive devices, and other information relating to the state of the high-speed electronic-component mounting device 18.

The multi-purpose electronic-component mounting device 22 will be described.

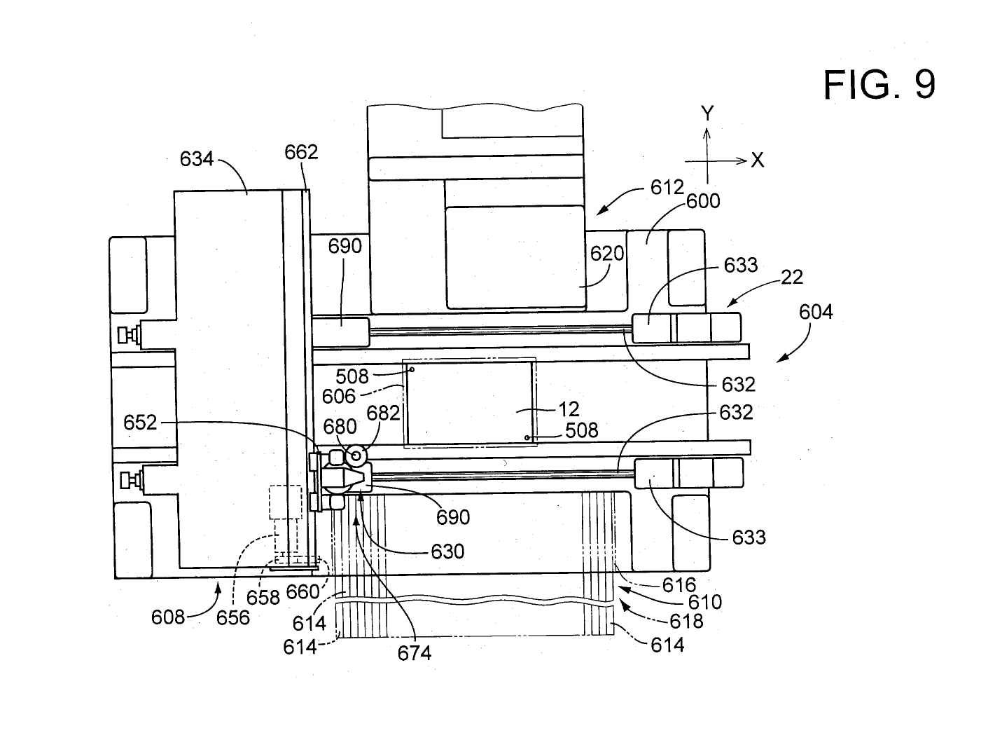

Although the component-holding heads 532 provided in the high-speed electronic-component mounting device 18 are held by the indexing body 530 such that the component-holding heads 532 can be turned about the vertical axis of rotation of the indexing body 530, a component-holding head used in the general-purpose electronic-component mounting device 22 to hold the electronic component 468 by suction is movable by an XY positioning device in a horizontal plane parallel to the surface of the printed-wiring board 12, in mutually perpendicular X-axis and Y-axis directions. This general-purpose electronic-component mounting device 22 will be described referring to FIG. 9. The general-purpose electronic-component mounting device 22 is used to mount primarily the electronic components 468 of relatively large sizes or unique shapes on the printed-wiring board 12. This type of electronic-component mounting device is known as disclosed in Japanese Patent No. 2824378.

In FIG. 9, reference sign 600 denotes a machine base serving as a main body of the system of the electronic-component mounting device. On the machine base 700, there are disposed a printed-wiring-board conveyor 604 arranged to transfer a circuit substrate in the form of the printed-wiring board 12 in the X-axis direction (in the right and left direction as seen in FIG. 9), a substrate holding device in the form of a printed-wiring board holding device 606 arranged to hold the printed-wiring board 12, a component-mounting device 608 arranged to mount the electronic components 468, and component-supplying devices 610, 612 arranged to supply the component-mounting device 608 with the electronic components 468.

In the present embodiment, the printed-wiring board 12 is transferred by the printed-wiring-board conveyor 604 such that the board 12 maintains a horizontal attitude. The printed-wiring board 12 is stopped by a stopper device (not shown) at a predetermined working position, and held by the printed-wiring-board holding device 606 disposed at a portion of the machine base 700 corresponding to the predetermined working position. In the present embodiment, the printed-wiring board 12 is held such that its component-mounting surface on which the electronic components 468 are to be mounted extends in the horizontal direction.

As shown in FIG. 9, the component-supplying devices 610, 612 are fixedly disposed on respective opposite sides of the printed-wiring-board conveyor 604 such that the component-supplying devices 610, 612 are spaced from each other in the Y-axis direction perpendicular to the X-axis direction in the XY coordinate system. In the illustrated example, the component-supplying device 610 is of feeder type while the component-supplying device 612 is of tray type.

The component-supplying device 610 of feeder type has a component supply table 618 including a feeder carriage 616 on which a multiplicity of feeders 614 are mounted such that component-supply portions of the feeders 614 are arranged along a line, in this example, along the X-axis direction. Like the feeders 466 described above, each of the feeders 614 is arranged to feed a carrier tape accommodating the electronic components 468, so that the electronic components 468 are supplied from the carrier tape.

The component-supplying device 612 of tray type has component trays 620 which accommodate the electronic components 468 and which are supported by respective multiple component-tray accommodating boxes that are stacked in the vertical direction. A component-holding head 630 which will be described is arranged to sequentially receive the electronic components 468 from the component tray 620. This component-supplying device 612 of tray time is similar to a component-supplying device as disclosed in JP-B2-2-57719.

In the component-mounting device 608, the component-holding head 630 is moved along a straight line having components in the mutually perpendicular X-axis and Y-axis directions, to transfer the electronic component 468 onto the upper component-mounting surface of the printed-wiring board 12. To this end, two ballscrews 632 are disposed on the machine base 600, on respective sides of the printed-wiring-board conveyor 604 which are opposite to each other in the Y-axis direction, as shown in FIG. 9. The ballscrews 632 extend in the X-axis direction. With these ballscrews 632 being rotated by an X-axis slide drive motors 633, the X-axis slide 634 is moved to a desired position in the X-axis direction.

As shown in FIG. 9, the X-axis slide 634 has a length sufficient to bridge the component-supplying device 610 of feeder type and the component-supplying device 612 of tray type, while extending across the printed-wiring-board conveyor 604.

On the X-axis slide 634, there is disposed a ballscrew (not shown) extending in the Y-axis direction. A Y-axis slide 652 has a nut held in engagement with the ballscrew. With the ballscrew being rotated by a Y-axis slide drive motor 656 through gears 658, 660, the Y-axis slide 652 is moved to a desired position in the Y-axis direction while being guided by guiding members in the form of a pair of guide rails 662. The X-axis slide 634, Y-axis slide 652 and the drive motor to move these slides cooperate to move the component-holding head 630 to a desired position in the horizontal plane.

The component-holding head 630 is supported by the Y-axis slide 652 such that the head 630 is vertically movable and rotatable about its axis. There are provided an axially head moving device in the form of a head elevating and lowering device (not shown) for elevating and lowering the component-holding head 630, and a head rotating device (not shown) for rotating the component-holding head 630 about its axis. The component-holding head 630, head elevating and lowering device, head rotating device 772, etc. constitute a component-mounting unit 674. While the present embodiment has only one component-mounting unit 674, a plurality of component-mounting units may be provided. For instance, a plurality of component-mounting units 674 may be disposed on the Y-axis slide 652 such that the component-mounting units 674 are arranged in the Y-axis direction.

The component-mounting unit 674 in the present embodiment is similar to a component-mounting unit as disclosed in Japanese Patent No. 3093339. No further description of the component-mounting unit 674 will be provided since it does not directly relate to the present invention.

On the Y-axis slide 652, there is also fixedly mounted a fiducial-mark camera 680 arranged to take images of a plurality of fiducial marks 508 provided on the printed-wiring board 12. In the present embodiment, the fiducial-mark camera 680 is constituted by a CCD camera capable of taking a two-dimensional image of an object. An illuminating device 682 is provided corresponding to the fiducial-mark camera 680, to illuminate the fiducial marks 508 and their vicinity.

On the X-axis slide 634, there are fixedly disposed two imaging devices 690 at respective two positions corresponding to the two ballscrews 632 provided to move the X-axis slide 634. Namely, one of the imaging devices 690 is disposed between the component-supplying device 610 of feeder type and the printed-wiring board 12, while the other imaging device 690 is disposed between the component-supplying device 612 of tray type and the printed-wiring board 12. These imaging devices 690 are identical with an imaging device as disclosed in Japanese Patent Application No. 2001-220967 or the corresponding U.S. patent application Ser. No. 10/1197,458. No further description of the imaging devices 690 will be provided since they do not directly relate to the present invention.

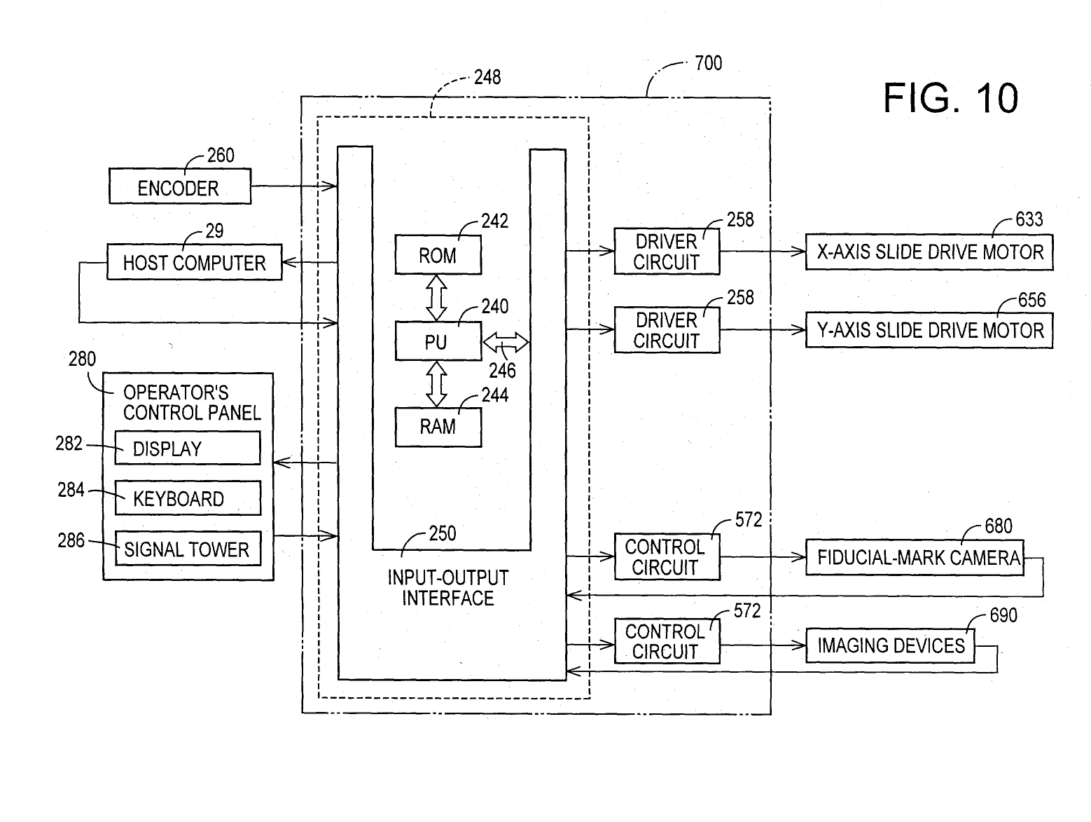

The multi-purpose electronic-component mounting device 22 is provided with control means in the form of a control device 700 as shown in FIG. 10. Like the control device 220 described above, the control device 700 is principally constituted by the computer 248. The same reference signs as used for the control device 220 will be used for the control device 700, to identify the functionally corresponding elements, which will not be described in detail. In the present embodiment, too, the drive sources such as the X-axis slide drive motor 633 are servomotors, operating angles of which are detected by encoders 260 and fed to the computer 248. The RAM 244 stores various programs (not shown) such as those for a main routine and an electronic-component mounting program, and various sorts of data necessary for executing those programs.

The control device 700 is connected to the host computer 29, so that the control device 700 can transmit to the host computer 29 information relating to the state of the general-purpose electronic-component mounting device and receive commands fed from the host computer 29.

The inspecting device 28 is almost identical in construction with the multi-purpose electronic-component mounting device 22 described above. The same reference signs as used for the multi-purpose electronic-component mounting device will be used to identify the corresponding elements of the inspecting device 28, and the inspecting device 28 will be only briefly described. On the Y-axis slide 652, there is fixedly disposed an imaging device in the form of an inspecting camera 710 for taking images of the electronic components 468 as mounted on the printed-wiring board 12. The inspecting camera 710 is constituted by a CCD camera capable of taking a two-dimensional image of an object. An illuminating device 712 is provided corresponding to the inspecting camera 710, to illuminate the electronic components 468 and their vicinity.

The inspecting device 28 is provided with a control device 712 which is similar to the above-described control device 220. The RAM 242 of the computer 248 stores various programs such as those for a main routine and an inspecting program. The control device 712 is connected at its input-output interface 250 to the host computer 29, and is arranged to transmit to the host computer 29 information relating to a result of the inspection.

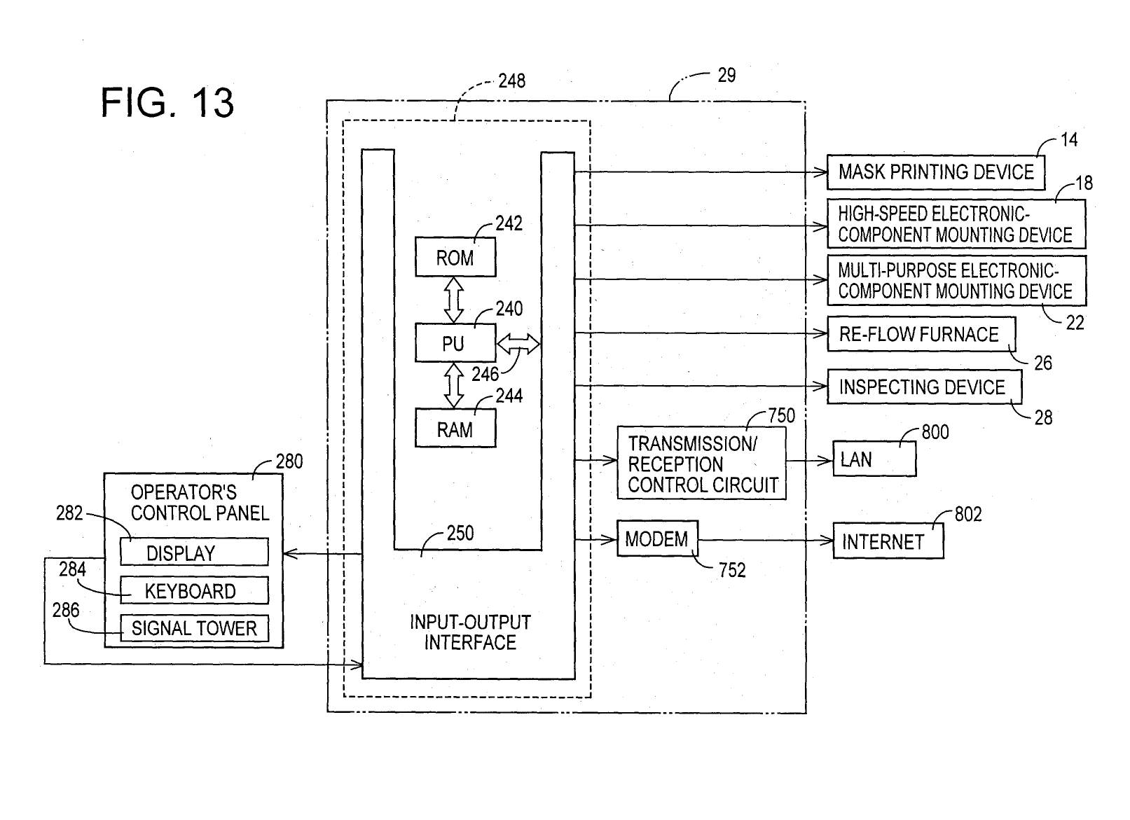

Like the above-described control device 220, the host computer 29 is principally constituted by the computer 248 incorporating the PU 240, ROM 242, RAM 244 and bus 246, as shown in FIG. 13. The host computer 29 is provided with a transmission/reception control circuit 750 and a MODEM 752. As described below in detail, the host computer 29 is connected through the transmission/reception control circuit 750 to a local area network (LAN) 800 within a factory, and through the MODEM 752 and a public communication line or network 754 to an internet 802. As shown in FIG. 1, the LAN 800 is connected to the public communication network 754 through a fire wall, to prevent an illegal or unauthorized access to the LAN 800.

The ROM 242 of the host computer 29 stores parameters necessary to control the working devices in the form of the mask printing device 14, electronic-component mounting devices 18, 22, re-flow furnace 26 and inspecting device 28. The host computer 29 selects the appropriate parameters to be transmitted to the control devices 220, 256, 700, 712 for those working devices. Described in detail, taking the mask printing device 14, for example, the pressure of extrusion of the solder paste from the printing head 134 and the moving speed of the printing head 134 are predetermined for the specific kinds of the mask 64 (specific configurations of the apertures 65) and the specific kinds of the printing material. The host computer 29 selects the values of the extrusion pressure of the solder paste and the moving speed of the printing head 134, which are appropriate to the specific printing operation to be performed. The host computer 29 transmits the selected values to the control device 220. For the electronic-component mounting devices 18, 22, the setups for mounting the electronic components 478 and the kinds and mounting spots of the electronic components 468 are stored for the specific kinds of the printed-wiring boards 12. The host computer 29 transmits to the control devices 560, 700 the appropriate information depending upon the specific kind of the printed-wiring board 12 on which the electronic components are to be mounted.

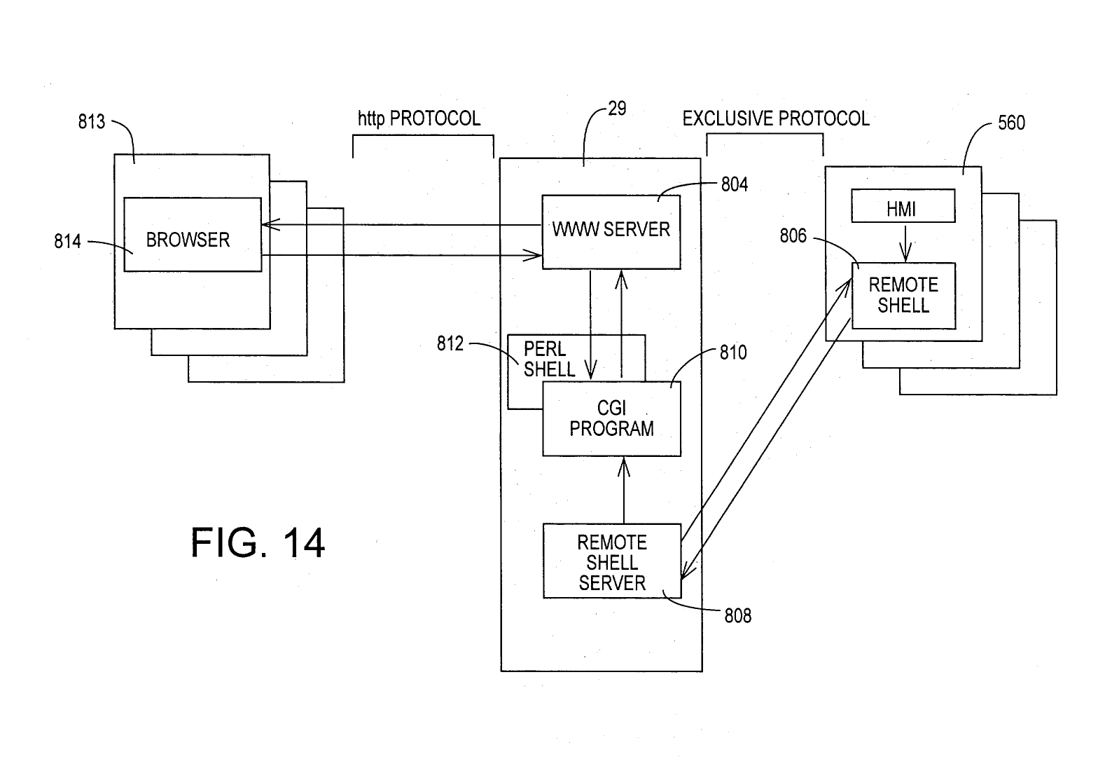

As indicated above, the host computer 29 is connected to the local area network (LAN) 800 within the factory, through a private communication line or network, and to the internet 802 through the public communication network 754. As shown in FIG. 14, the host computer 29 is provided with a WWW server 804, through which the host computer 29 obtains from time to time working information relating to the working devices of the printed-wiring-board working system 10, and delivers the working information according to a HTTP (hypertext transfer protocol). It is noted that FIG. 14 shows the control device 560 for the high-speed electronic-component mounting device 18, as an example of the control devices for the working devices. The working information is delivered to a production manager(s) within the factory and a business manager(s) of the company, and to equipment personnel of a supplier of each working device, who is in charge of the working device. Thus, the working information is available to those managers and personnel at locations remote from the production site, as if the working information were obtained at the production site. The production manager, business manager and equipment supplier personnel who monitor the status of the working system 10 are collectively referred to as “administrator”. The HTTP is a protocol used for transmission and reception of information such as files between a WWW server and a WWW browser.

In the present embodiment, a plurality of computers 813 are provided outside the working system 10, such that the computers 813 are connectable to the host computer 29 through the LAN 800 or public communication network 754. By using the computers 813, the administrator can see a view almost identical with a view provided on the display 282 of the operator's control panel 280 of each working device. The external computer 813 connected to the host computer 29 through the public communication network 754 is also connected to the host computer 29 through the fire wall 760, to prevent an unauthorized access.

The function of delivering the working information will be explained in greater detail.

As shown in FIG. 14, the control device 560 is provided with a shell in the for of a remote shell 806 for transmission and reception of information between the control device 560 and the host computer 29, while the host computer 29 is provided with a remote shell server 808, so that transmission and reception of information between the host computer 29 and the control device 560 is available. For instance, information which the operator of the high-speed electronic-component mounting device 18 can obtained through the operator's control panel 280 which is a human-machine interface (HMI) can be transmitted to the host computer 29 through the remote shell 806 and the remote shell server 808. The host computer 29 is further provided with a CGI (common gateway interface) program 810 and the WWW server 804, which permit transmission and reception of information between the WWW server 804 and the remote shell server 808 through a perl shell 812. The WWW server 804 also permits transmission and reception of information using the HTTP, to and from the computers 813 outside the working system 10. The shells 806, 812 are a software interface between the users and an operating system (OS), while the CGI program is an interface for the WWW server to transmit and receive information to and from a backend program called “gateway”, so that the interface is used when a WWW browser sends an inquiry to the remote shell server 808 serving as a data base server, via the WWW server.

In the manner as described above, the host computer 29 delivers the information relating to the working system 10, through the HTTP, so that the information is available to the administrator through the WWW browser 814 provided at the computers 813 outside the working system 10.

The host computer 29 provided with the WWW server 804 can receive operating information for operating the host computer 29 or each of the working devices. As described below in detail, the external computers 813 are capable of displaying views almost identical with the views provided on the displays 282 of the operator's control panels 280 at the working devices. That is, operating commands can be entered according to the views provided on displays at the locations of the computers 813, as if the operating commands were entered through the operator's control panels 280. The operating information includes, for example, view-changing commands for changing the view of the display 282 of each working machine to be displayed at the location of each external computer 813, and operation control commands for controlling the working operation of each working device.

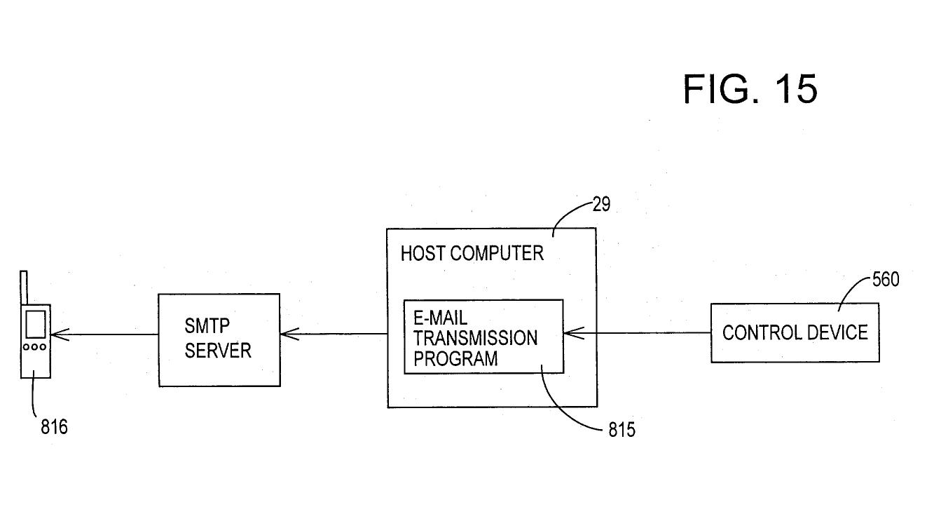

As shown in FIG. 15, the host computer 29 stores an e-mail transmission program 815 for transmitting an electronic mail through the internet 802 (shown in FIG. 13). In the present embodiment, each of the operators present at the production site and responsible for monitoring and maintaining the working system 10 and replenishing the working system 10 with the electronic components carries a portable remote terminal in the form of a portable telephone or cellular phone 816 serving as a portable terminal or receiver to receive an electronic mail. When the host computer 29 receives information that the working system 10 has been depleted of the electronic components or has been stopped, or any other information that should be transmitted to any operator, the host computer 29 transmits to the operator at the site of the appropriate working device an electronic mail including information relating to the state of the working device. Thus, the operator of each working device can be informed by the electronic mail of a need of going to the production site, so that the operator is not required to always attend the working device at a location where the operator can make visual inspection of the display 282 and signal tower 286.

The operation of the printed-wiring-board working system 10 arranged as described above will be described. The operation of the present working system 10 on the printed-wiring board is described in the above-identified Japanese Patent No. 2824378, and JP-A-2001-223500 which is a publication of a Japanese Patent Application filed by the assignee of the present applicant, or the corresponding U.S. patent application Ser. No. 09/721,953.

Initially, the printed-wiring board 12 is loaded by a board loading device (not shown) onto the mask printing device 14, and is supported and positioned at the printing position by the printed-wiring-board conveyor 32 and the printed-wiring-board supporting and elevating/lowering device 34. The horizontal position of the mask 64 is adjusted, and the printed-wiring board 12 is elevated by the elevating and lowering device 62, for contact with the lower surface of the mask 64. In this condition, the printing head 134 is moved in contact with the upper surface of the mask 64, so that the solder paste is extruded from the outlet, into the apertures. 65, while a portion of the extruded solder paste which is outside the apertures 65 is scraped off the mask 64 by one of two outlet defining members which is located upstream of the other member. Thus, the appropriate amount of the solder paste is applied by printing to the printed-wiring board 12. After the printing operation is completed, the printed-wiring board 12 is lowered by the elevating and lowering device 62 to a position at which the board 12 is transferable. The board 12 is transferred to the high-speed electronic-component mounting device 18. Concurrently with the printing operation described above, the mask cleaning device 42 is moved by the slide 122, together with the printing head 134, relative to the mask 64, for cleaning the mask 64.

When the printed-wiring board 12 has then reached the high-speed electronic-component mounting device 18, the board 12 is supported by the printed-wiring-board holding device 458. Initially, the board 12 is located at the imaging position at which the images of the two F marks 508 are taken by the F-mark camera 510, to detect horizontal and angular positioning errors of the printed-wiring board 12 as held by the holding device. The component-mounting spots on the printed-wiring board 12 at which the electronic components 468 are to be mounted are adjusted on the basis of the detected positioning errors, so that the XY table 484 is moved to position the printed-wiring board 12 such that the adjusted component-mounting spots are located right below the component-mounting position of the component-mounting device 456. Each component-holding head 532 of the component-holding device 456 receives the electronic component 468 from the feeder 466 at the component-receiving position, and the image of the electronic component 468 as held by the component-holding head 532 is taken by the imaging device 552 at the component-hold-position detecting position. After the angular positioning error of the electronic component 468 is eliminated at the component-hold-position rectifying position, the component-holding head 532 reaches the component-mounting position. At the component-mounting position, the suction nozzle 550 is lowered to mount the electronic component 468 onto the printed-wiring board 12. The suction nozzle 550 is communicated with the positive pressure source, to release the electronic component 468, and is then elevated, with the electronic component 468 remaining on the printed-wiring board 12. Thus, one cycle of operation to mount one electronic component is completed.

Then, the printed-wiring board 12 is loaded onto the multi-purpose electronic-component mounting device 22, for mounting the other electronic components 468 on the printed-wiring board 12. The printed-wiring board 12 is moved by the printed-wiring-board conveyor 604, to the component-mounting position, and positioned and held by the printed-wiring-board holding device 606. The component-holding unit 674 is moved in the horizontal direction to receive the electronic component 468 from one of the component-supplying devices 610, 612, and is further moved to a component-mounting position right above the corresponding component-mounting spot on the printed-wiring board 12. During this movement, the component-mounting unit 674 passes the imaging device 690, so that the image of the electronic component 468 as held by the unit 674 is taken. During the movement of the component-mounting unit 674 from the position of the imaging device 690 to the component-mounting position, the positioning errors of the electronic component 468 as held by the unit 674 are detected and eliminated, and the electronic component 468 is mounted.

After all of the electronic components 468 have been mounted, the printed-wiring board 12 is transferred into the re-flow furnace 26, and heated therein, to solidify or cure the solder paste for fixing the electronic components 468.

When the printed-wiring board 12 leaving the re-flow furnace 26 has reached the inspecting device 28, the board 12 is transferred by the printed-wiring-board conveyor 604 to the predetermined position at which the board 12 is held by the printed-wiring-board holding device 606. Initially, the images of the fiducial marks 508 are taken by the inspecting camera 710 to detect the position of the board 12. Then, local areas of the surface of the printed-wiring board 12 are sequentially imaged to check if the electronic components 468 have been mounted at the respective predetermined component-mounting spots. If each electronic component 468 is found to have been mounted at the predetermined component-mounting spot, the electronic component 468 is then inspected to check if its kind and mounting attitude are correct. A result of the inspection is transmitted from time to time to the host computer 29. The result of the inspection by the inspecting device 28 described above includes the horizontal and angular positions of each electronic component 468. Where the printed-wiring board 12 is found defective, the result of the inspection includes information relating to the component-mounting spot of each defective electronic component 468 which has not been mounted correctly. On the basis of the result of the inspection, the host computer 29 statistically processes data such as data indicative of the operating efficiency of the working system 10, a ratio of the defective printed-wiring boards 12, and causes of the defects, and delivers information obtained by the statistical data processing.

The host computer 29 receives from each working device various sorts of information other than the result of the inspection described above, and delivers these sorts of information in suitable formats. Described in detail, the host computer 29 receives electronic mails from the cellular phones 816 and WWW information from the computers 813 provided with the browsers 814. It is noted that information transmitted to and from the host computer 29 by using the HTTP is referred to as the WWW information. The information received from each working device includes information indicative of the present operating state, and other sorts of information, for instance, values detected by the various sensors such as the sensors 144, 180, which include the pressure of extrusion of the solder paste and the contact load and moving speed of the printing head 134 of the mask printing device 14. The information received from the electronic-component mounting devices 18, 22 includes information relating to the remaining amount of the electronic components, and the inspection results relating to the hold positions of the printed-wiring board 12 and the electronic-components 468. All of those sorts of information are delivered through the WWW server 808, while information of such nature that must be transmitted to the operators of the working devices is transmitted by an electronic mail to the appropriate operator, as needed. The information of that nature includes error-stop information indicating that the working system 10 has been stopped due to an error, and component-depletion information indicating that the working system 10 has been depleted of the electronic components. In the present embodiment, the error-stop information and the component-depletion information are delivered as both the electronic mail and the WWW information. These sorts of information will be described one after another.

Initially, the component-depletion information to be transmitted by the electronic mail will be described.

The control devices 560, 700 monitor the remaining amount of the electronic components 468 in each feeder 466 of the high-speed and multi-purpose electronic-component mounting devices 18, 22. Suppose the remaining amount of the electronic components 468 in a given one of the feeders 466 of the high-speed electronic-component mounting device 18 has been reduced below a predetermined value, for example, the signal tower 280 of the corresponding control device 560 is illuminated, and the display 282 provides a warring indication to that effect, so that the operator is informed that the feeder 466 will be depleted of the electronic components 468 in the near future. Further, the component-depletion information indicating the future depletion of the electronic components is transmitted to the host computer 29. Upon reception of the component-depletion information, the host computer 29 immediately sends an electronic mail to the cellular phone 816 of the operator in charge of the high-speed electronic-component mounting device 18, to inform the operator that the appropriate feeder will be depleted of the electronic components.

Similarly, when the remaining amount of the electronic components 468 that can be supplied from at least one of the component-supplying devices 610, 612 of the large-size electronic-component mounting device 22 has been reduced below the predetermined value, the signal tower 286 is illuminated and the display 282 provides a warning indication of the future depletion of the electronic components, and the electronic mail is sent from the host computer 29 to the cellular phone 816 of the appropriate operator.

It is not essential that the component-depletion information is displayed on the display 282 while at the same time the electronic mail is sent to the cellular phone 816. Namely, displaying the component-depletion information on the display 282 and sending the electronic mail may be effected at different times. For example, where the operator is present at the production site and able to quickly deal with the depletion of the electronic components 468, the electronic mail is not sent to the cellular phone 816. Where the operator cannot visually inspect the signal tower 286 and the display 282, the electronic mail is sent to the cellular phone 816. Described in detail, the component-depletion information is transmitted to the host computer 29, and the electronic mail may be sent, for example, where the operator does not show any response to a warning indication of the depletion of the electronic components in the electronic-component mounting device 18 or 22, for more than a predetermined time after the warning indication is provided. The warning indication may be given on the display or may be effected by illumination of the signal tower. The operator's response may be an entry of a signal indicating the operator's confirmation of the warning indication, or replacement of the feeder 466 by the operator.

In the present embodiment, the signal tower 286 is illuminated, and the electronic mail is sent to the cellular phone 816 of the operator, also when the working operation of the working system 10 is stopped due to an error. Accordingly, the operator can eliminate a cause for the error, to resume the working operation of the working system 10, according to information provided on the display 282.

Where the operator determines that the operator is unable to deal with an abnormality of the working system 10 which has taken place, the operator first contacts the production manager within the factory, by phone or any other suitable communication means. The production manager who has been contacted by the operator connects his or her computer 813 to the host computer 29 of the working system 10 through the LAN 800, and retrieves information relating to the status of the working system 10, such as information on any error of the working devices and the result of the inspection. Described in detail, the production manager specifies the working device the information of which is required to be obtained, so that the information provided on the display 282 of the specified working device is also provided on the display connected to the computer 813 in question. Where a message regarding the error of the working device is provided on the display 282, the production manager can obtain the information indicative of the error of the working system 10, so that the production manager is not required to go to the production site. Accordingly, the error can be dealt with in a short time. Described in detail, where the operator can deal with abnormality of the working system, such as depletion of the electronic components in the electronic-component mounting device 18, 22, the production manager can easily instruct the operator, while viewing the information which is almost the same as the information the operator is viewing.

Where the production manager within the factor is not able to deal with an abnormality of the working system, the production manager contacts by telephone, for instance, the equipment supplier personnel, who owns the computer 813 which is connectable through the internet to the host computer 29. Thus, the equipment supplier personnel at a location remote from the production site can grasp the status of the working device in question, and know the cause for an abnormality of the working device resulting in stopping of the working system 10, before the equipment supplier personnel goes to the production site. For instance, the equipment supplier personnel can place a purchase order for replacement parts necessary to eliminate the abnormality.

In the present embodiment, the production manager and the equipment supplier personnel can not only obtain the necessary information from the production site upon stopping of the working system 10, for example, but also monitor the working system for its operating efficiency, at a regular interval, so that the working system 10 can receive an appropriate maintenance service upon reduction of the operating efficiency, before an occurrence of an error in the working system 10, leading to an improvement of the operating efficiency. Where there exists an agreement between the user of the working system 10 and the equipment supplier, for a periodic maintenance service of the working system 10, the equipment supplier personnel periodically has an access to the WWW server 804, to obtain information on the production state of the working system 10, and in the event of an occurrence of any abnormality such as reduction of the operating efficiency, goes to the production site for the maintenance service of the working system 10, before a serious trouble takes place with the working system. Alternatively, the equipment supplier personnel instructs the production manager or the operator to perform an appropriate maintenance service of the working system 10, for preventing stopping of the working system due to the serious trouble, and thereby improving the operating efficiency.

Further, the efficiency of the maintenance of the working system can be improved since it is not essential to go to the production site for inspecting the working system.

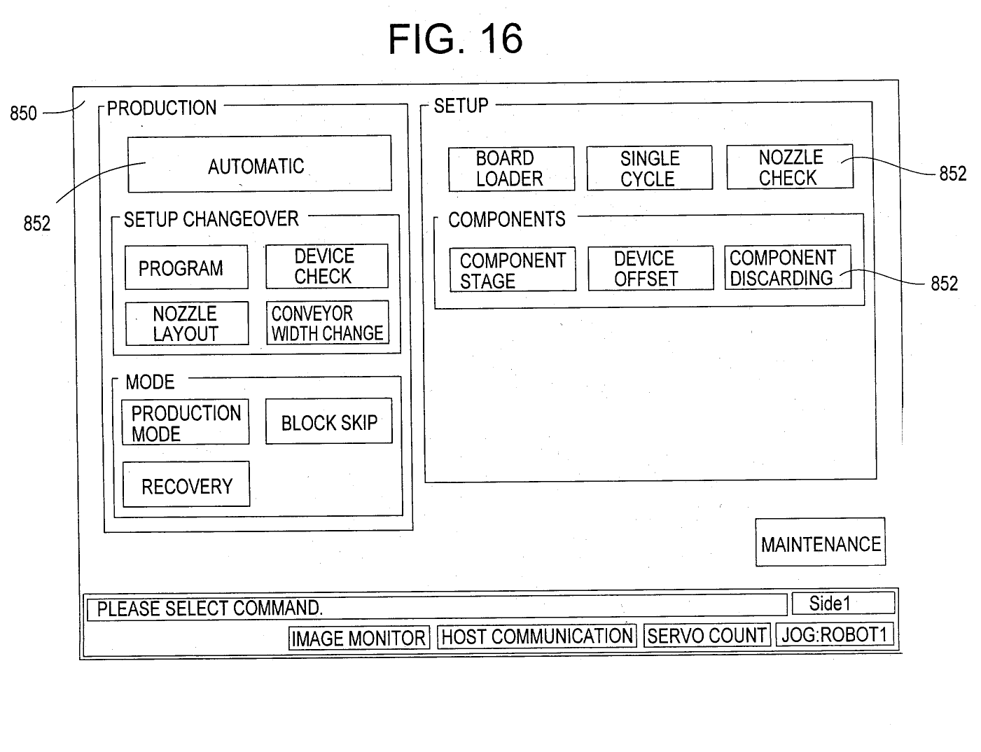

Described more specifically, the administrator initially identifies the working device to be inspected. Then, a view 850 provided on the display 282 of the identified working device as shown in FIG. 16 is retrieved through the remote shell 806, and data for the display view 850 are transmitted to the computer 813 through the CGI program 810 and the WWW server 804, so that the corresponding display view is provided on the display of the computer 813. Thus, the administrator at a remote location can see a display view similar to that provided on the operator's control panel 280 of each working device.

The display view 850 displayed on the display 282 of the operator's control panel 280 provides a plurality of command pushbuttons 852, so that commands can be entered by clicking on the respective command pushbuttons 852 in the display view. In the present embodiment wherein the command pushbuttons 852 are provided in the display view provided on the display of the external computer 813, the administrator can enter and execute the commands by clicking on the respective command pushbuttons 852 on the administrator's display. The command entered by activation of each pushbutton 852 is transmitted from the computer 813 to the control device 560 through the WWW server 804. Thus, the working devices can be commanded at a location remote from the working system 10. Described in detail, The commands include: evaluation commands for evaluating the working devices, on the basis of recorded error data and operating efficiency; maintenance commands for instructing maintenance service of the working devices; and setup changeover commands for effecting a change of the setup of each working device.

In an automatic operation mode of the working devices, it is not possible to enter the maintenance command and the setup changeover commands which may interfere with the working operations of the working devices.

When any of the above-indicated commands is entered, the display view provided on the display of the external computer 813 is changed to a view suitable for executing the entered command. In the present working system 10, each command has a function of changing the display view. Where an evaluation command for a given working device is entered through the external computer 813, for example, information relating to the operating state of that working device is displayed on the display of the external computer 813. Where a maintenance or setup changeover command is entered, the display provides a display view for specifying details of the maintenance or setup changeover.

As described above, the equipment supplier personnel can check each working device while the working devices are not in the automatic operation mode, and effect an appropriate maintenance service if necessary, by using the corresponding maintenance command. Where a serious trouble of any working device is expected, the equipment supplier personnel can notify the operator of this working device at the production site, of the expected trouble, to draw an attention of the operator to the expected trouble, or to recommend an early repair or adjustment of the working device. If the necessary maintenance service can be accomplished by the production manager or the operator, for example, the equipment supplier personnel can provide more detailed instructions to aid the production manager or operator. If the necessary maintenance service must be performed by the equipment supplier personnel, this service can be performed with high efficiency. The entry of the commands at a remote location can be made by the production manager within the factor, in the event of occurrence of any error as described above.

Further, the business manager of the company who manages the factory can also have an access to the present working system 10, and can obtain updated information when needed, by using the evaluation commands, without waiting for daily or monthly reports relating to the production.

The following detailed description referring to some examples, most of which is redundant with the foregoing description, refers to a relationship between the display view provided in a manufacturing system and the display view provided on the display of each external computer 813 serving as an administering apparatus for administering the manufacturing system, and an operation through the external computer 813 to control the manufacturing system through its display view.

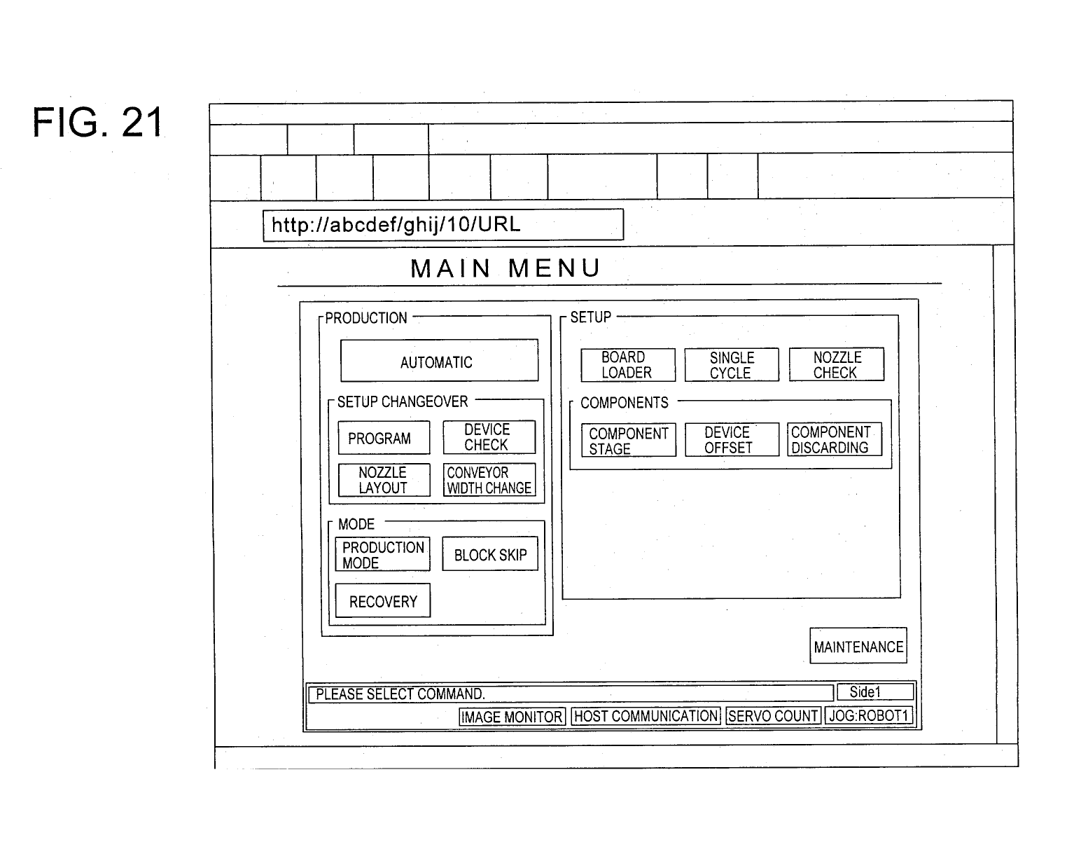

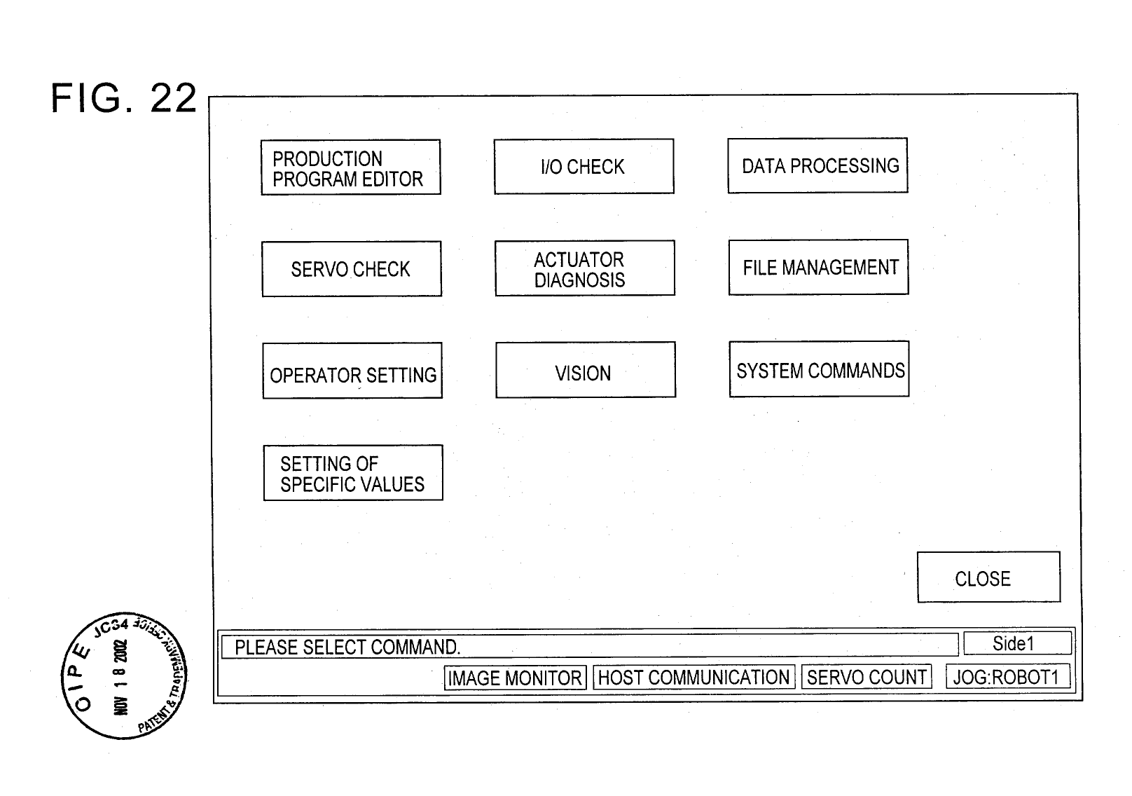

FIG. 16 shows the display view provided on the display 282 of the operator's control panel 280 of each working device, which display view is used to control the working device. When the display view is provided on the operator's control panel 280, the external computer 813 provides a display view as shown in FIG. 21. Namely, the display view provided on the display of the external computer 813 includes the entirety of the display view provided on the display 282 of the operator's control panel 280. When the operator clicks on a MAINTENANCE pushbutton in a right lower portion of the display view as shown in FIG. 16, the color of this pushbutton is changed, and the display view is changed to a display view as shown in FIG. 22. Simultaneously, the display view on the display of the external computer 813 is also changed to the display view as shown in FIG. 22. The display 282 is of a touch panel type wherein the clicking is achieved by touching the pushbuttons.

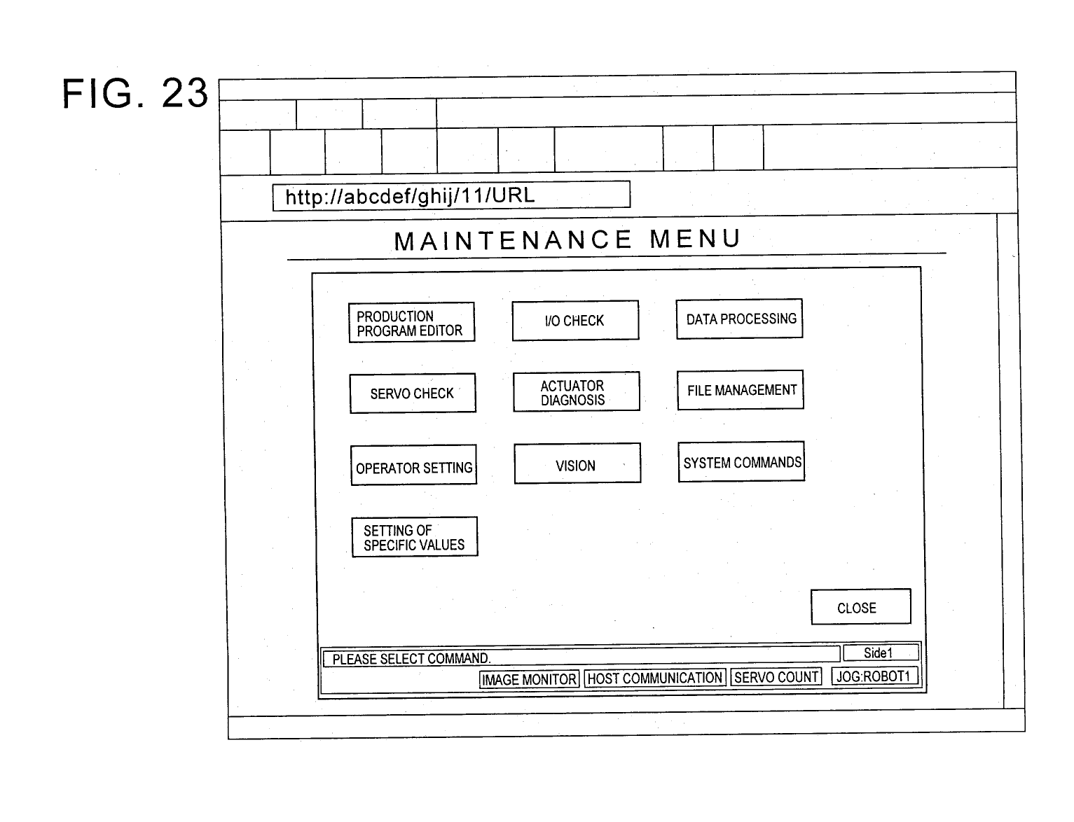

When the external computer 813 is operated to click on the MAINTENANCE pushbutton in its display view (which includes the entirety of the display view as shown in FIG. 16), the color of the corresponding MAINTENANCE pushbutton in the display view provided on the display 282 of the operator's control panel 280 is changed, and the display view is changed to an operation control view as show in FIG. 22, as in the case where the operator manipulates the display 282. In response to a change of the display view on the display 282, the display view on the display of the external computer 813 is also changed to a display view as shown in FIG. 23.

That is, the external computer 813 transmits to the manufacturing system operating information obtained on the basis of an operation performed on itself. The manufacturing system which has received the operating information controls the display view provided on the operator's control panel 280 of its working device. The operating information includes position information indicative of the position of any control pushbutton on the display 282 of the operator's control panel 280, which corresponds to the control pushbutton operated on the display of the external computer 813. On the basis of the position information, the appropriate pushbutton of the operator's control panel 280 is operated. Thus, the operating information is correlated to the position within the display view.

In the present embodiment, an operation on the side of the external computer 813 causes a change in the color of the corresponding pushbutton on the display 282 of the operator's control panel 280, so that the operator of the manufacturing system can recognize the operation. Namely, the contents of the operation on the side of the external computer 813 are indicated within the operation control view provided on the display 282 of the operator's control panel 280. Accordingly, the operator can accurately grasp an intention of the administrator who operated the external computer 813. For instance, the operator and the administrator have a conversation by telephone, while observing the same display views, making it easier to grasp the state of the working device, and enabling the administrator to more exactly instruct the operator regarding the necessary manipulation using the display view.

It will be understood from the foregoing explanation of the present embodiment that the transmission/reception control circuit 750, the MODEM 752 and a portion of the host computer 29 assigned to execute the e-main transmission program 815 cooperate to constitute an electronic-mail transmitting device and an operator-used-information transmitting device, while the transmission/reception control circuit 750, the MODEM 752 and the WWW server 804 cooperate to constitute an administrator-used-information transmitting device.

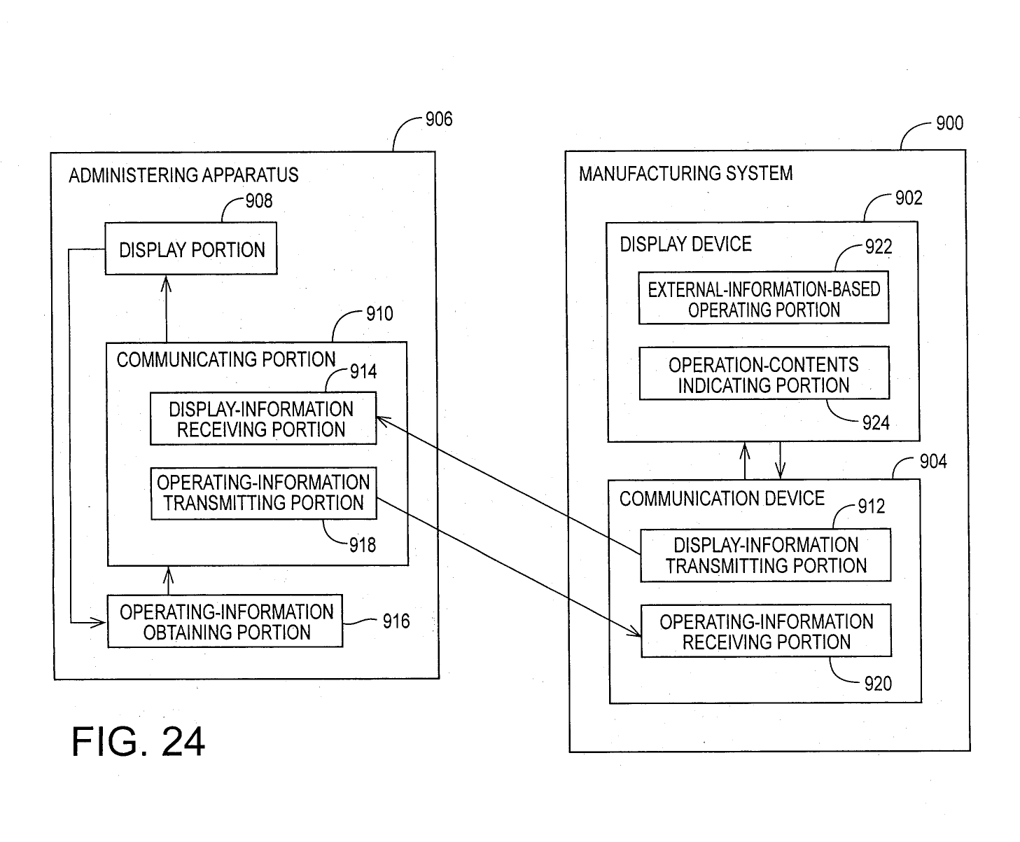

The block diagram of FIG. 24 schematically shows the functions of the manufacturing system and the functions of the administering principally constituted by each external computer 813, in connection with the display views and the operations through the display views. The functional block diagram of FIG. 24 will be described in relation to the foregoing descriptions. The manufacturing system 900 is provided with a display device 902 for each working device, which display device is principally constituted by the operator's control panel 280 and the display 282 and arranged to indicate the state of the working device and provide display views. The manufacturing system 900 is further provided with a communication device 904 for communication with the administering apparatus, which communication device 904 includes: the host computer 28 incorporating the transmission/reception control circuit 750, the MODEM 752 and the WWW server 804; and the LAN 800 connected to the host computer 29 and the working devices. The administering apparatus 906, which is principally constituted by the external computer 813 having the browser 814, includes: a display portion 908 principally constituted by a display and a portion for controlling the display; and a communicating portion 910 for communication with the manufacturing system 900.

The communication device 904 is provided with a display-information transmitting portion 912 transmitting portion functioning to transmit display information relating to the display view provided on the display device 902, while the communicating portion 910 is provided with a display-information receiving portion 914 functioning to receive the display information. The administering apparatus 906 also includes an operating-information obtaining portion 916 functioning to obtain operating information relating to an operation performed on the administering apparatus 906 to manipulate the display view provided on the display device 902. The communicating portion 910 is provided with an operating-information transmitting portion 918 functioning to transmit the operating information to the manufacturing system 900. The communicating device 904 is provided with an operating-information receiving portion 920 functioning to receive the operating information, while the display device 902 is provided with an external-information-based operating portion 922 functioning to control its display view on the basis of the received operating information. The display device 902 is further provided with an operation-contents indicating portion 924 functioning to indicate, within its display view, the contents of an operation performed by the administering apparatus 906 on the basis of information correlated to the display view.

In the present printed-wiring-board working system 10 wherein the host computer 28 includes the WWW server 804 and the e-mail transmission program 815, urgent information such as information indicating stopping of the working system 10 is transmitted by an electronic mail, while different kinds of information including the information transmitted by the electronic mail are transmitted using the HTTP, so that the status of the working system 10 can be easily recognized at a remote location at which the working system 10 cannot be visually inspected. Information on the working system 10 can be obtained at a remote location, by using a WWW browser software commonly available, so that an exclusive software is not necessary for this purpose.,

In the present embodiment wherein the inspecting device 28 is disposed downstream of the re-flow furnace 26, the electronic components 468 fixed on the printed-wiring board 12 are inspected. However, an inspecting device or inspecting devices may be disposed at any other position or positions. For example, an inspecting device may be disposed downstream of each working device, to inspect a result of the working operation performed by each working device. Alternatively, each working device has a function of inspecting its working operation. In the latter case, each working device may be provided with an inspecting camera, or an F-mark camera for taking images of F marks may be used to take images for inspecting the working operation.

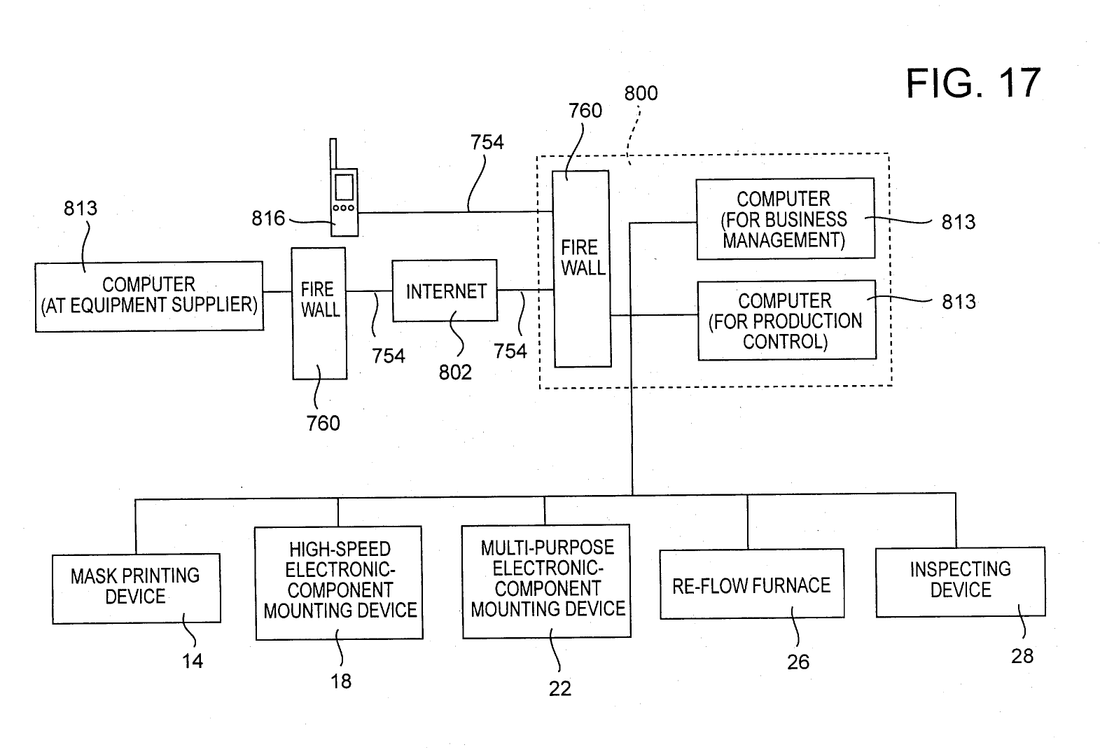

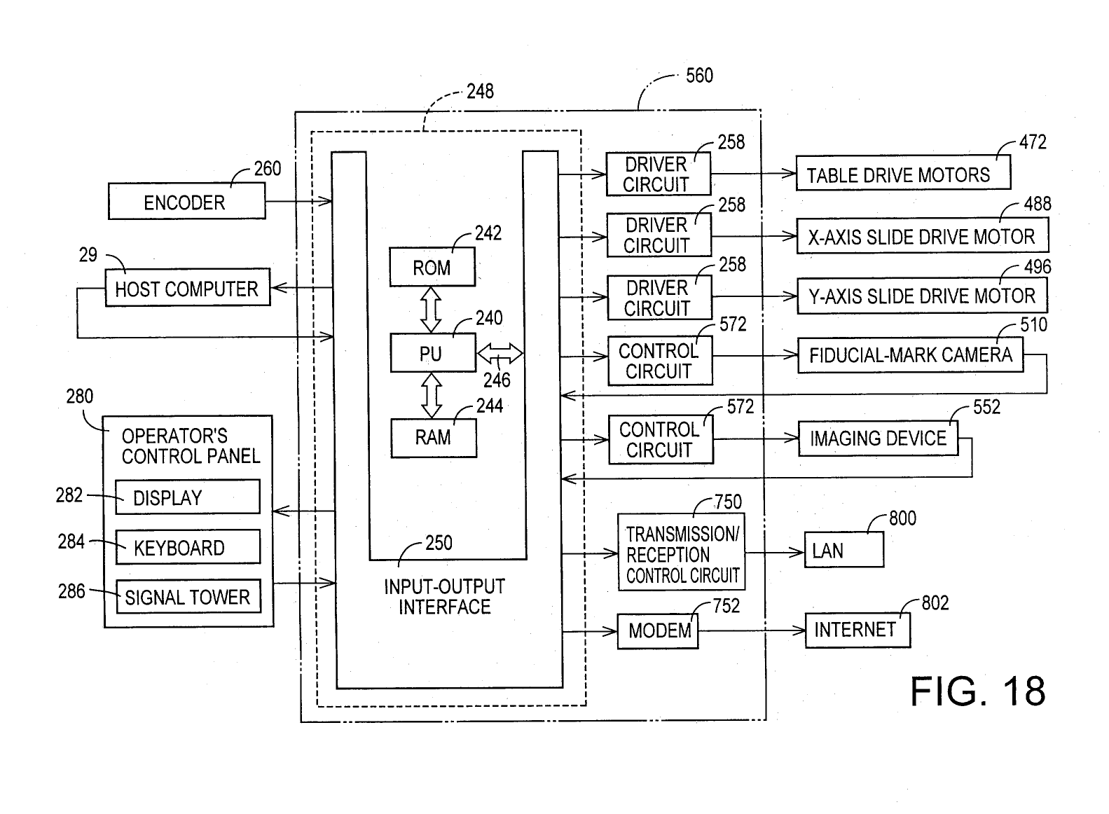

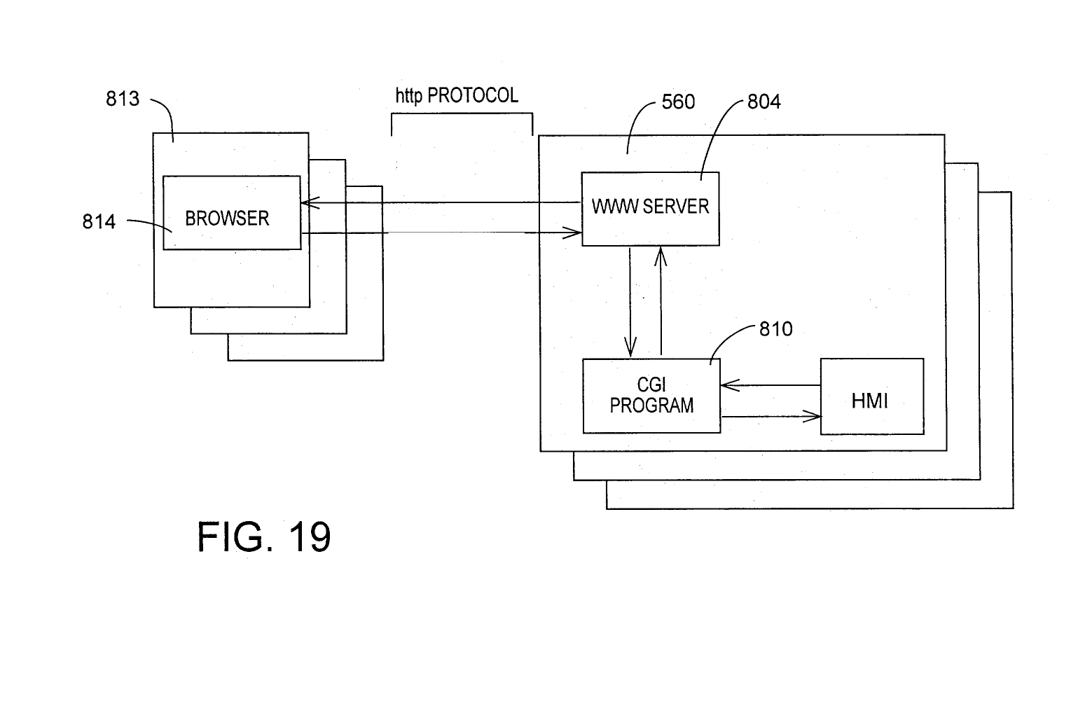

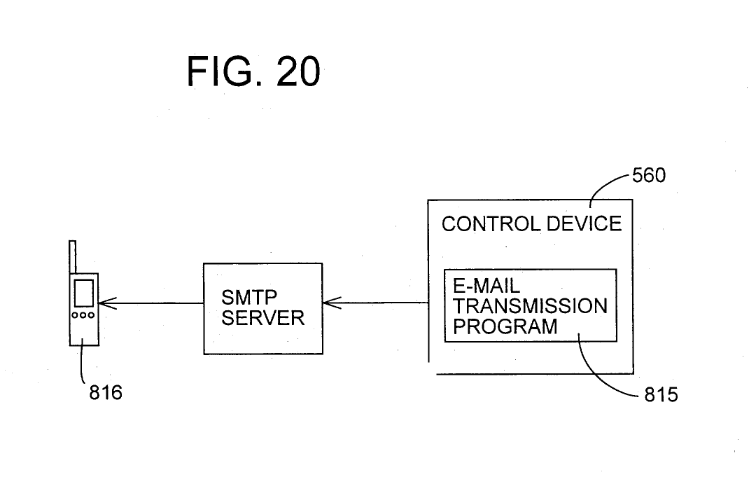

In the illustrated embodiment, the host computer 28 provided for controlling the working system 10 in a coordinated manner is provided with the WWW server 804 and the e-main transmission program 815. However, each working device may has the communicating function, as shown in FIGS. 17-20. In this case, the control device 220, 560, 700, 712 of each of the working devices (mask printing device 14, electronic-component mounting devices 18, 22 and inspecting device 28) is provided with the transmission/reception control circuit 750 and the MODEM 752, and its ROM 242 includes the WWW server 804 and stores the e-main transmission program 815. Each working device is connectable directly to the LAN 800 and the internet 802, to deliver information. Information provided on the operator's control panel 280 of each working device is retrieved by the CGI program 810, and delivered through the WWW server 804. It is noted that FIGS. 18 and 20 show the control device 560 of the high-speed electronic-component mounting device 18, by way of example.

In the present modified embodiment of the invention, each working device is connectable directly to the LAN 800 and the internet 802, and the host computer 29 is not essential.

While the several embodiments of this invention have been described in detail, for illustrative purpose only, it is to be understood that the present invention may be embodied with various changes and improvements, such as those described in the SUMMARY OF THE INVENTION, which may occur to those skilled in the art:

What is claimed is:

1. A manufacturing system including at least one working device operable to perform a predetermined working operation on an object, which working operation is at least a portion of a process of manufacturing a desired product, said manufacturing system comprising:
a communication device operable to effect at least one of transmission and reception of information through a public communication network.

2. A manufacturing system including at least one working device operable to perform a predetermined working operation on an object, which working operation is at least a portion of a process of manufacturing a desired product, said manufacturing system comprising:
a WWW server operable to deliver information relating to said at least one working device.

3. A manufacturing system including at least one working device operable to perform a predetermined working operation on an object, which working operation is at least a portion of a process of manufacturing a desired product, said manufacturing system comprising:
an electronic-mail transmitting device operable to transmit an electronic mail relating to a state of said at least one working device.

4. A manufacturing system according to claim 1, wherein said communicating device includes an operator-used-information transmitting device operable to transmit, to a portable remote terminal through said public communication network, information for use by an operator of said at least one working device.

5. A manufacturing system according to claim 4, wherein said information for use by said operator includes error-stop information informing said operator that said working device has been turned off due to an error.

6. A manufacturing system according to claim 4, wherein said at least one working device includes an electronic-component mounting device operable to mount electronic components on a printed substrate, and said information for use by said operator includes component-depletion information informing said operator that said electronic-component mounting device has been depleted or is expected to be depleted in the near future, of said electronic components of at least one kind.

7. A manufacturing system according to claim 1, wherein said communicating device includes an administrator-used-information transmitting device operable to transmit, to a terminal computer through said public communication network, information for use by an administrator of the manufacturing system, which information relates to said working operation of said at least one working device and includes information relating to an operating efficiency of said working device.

8. A manufacturing system according to claim 7, wherein said working device includes a display device operable to display a state thereof, and said information for use by said administrator includes information indicative of contents of display provided on by said display device.

9. A manufacturing system according to claim 1, wherein said working device includes an information receiving device operable to receive information through said public communication network.

10. A manufacturing system according to claim 9, wherein said working device includes a display device operable to display a state thereof, and said information receiving device includes a view-changing-command receiving portion operable to receive a view-changing command which commands said display device to change a display view provided on said display device.

11. A manufacturing system according to claim 9, wherein said information receiving device includes a remote-control-signal receiving portion operable to receive a remote control signal for remote control of said working device.

12. A manufacturing system according to claim 1, wherein said communication device includes an electronic-mail transmitting and receiving device operable for transmission and reception of an electronic mail to and from an external device through said public communication network.

13. A manufacturing system according to claim 1, wherein said communication device includes a WWW-information transmitting and receiving device operable for transmission and reception of a WWW information to and from an external device through said public communication network.

14. A manufacturing system according to claim 1, wherein said working device is a circuit-substrate working device operable to perform a predetermined operation on a printed substrate, and the manufacturing system is a printed-circuit-board manufacturing system operable to perform at least a portion of a process of manufacturing a printed-circuit board.

15. An administering system for administering a manufacturing system, at a location remote from said manufacturing system, said manufacturing system including at least one working device operable to perform a predetermined working operation on an object, which working operation is at least a portion of a process of manufacturing a desired product, said administering system comprising:
(a) a display device and (b) a communication device which are provided in said manufacturing system, said display device being operable to provide a display view indicating at least a state of said working device, said communication device being connected to said display device and provided with a display-information transmitting portion operable to transmit display information relating to said display view provided on said display device, said communication device being operable to effect transmission and reception of information through a communication network; and
an administering apparatus disposed at a location remote from said manufacturing system and provided with a communicating portion and a display portion, said communicating portion having a display-information receiving portion operable to receive said display information, and being operable to effect transmission and reception of information through said communication network, said display portion being operable to provide a display view including said display view provided on said display device, on the basis of said display information received.

16. An administering system according to claim 15, wherein said administering apparatus is provided with an operating-information obtaining portion operable to obtain operating information relating to an operation performed on said administering apparatus, and said communicating portion is provided with an operating-information transmitting portion operable to transmit said operating information,
and wherein said communicating device has an operating-information receiving portion operable to receive said operating information, and said display device is provided with an external-information-based operating portion operable to control its display view on the basis of said operating information received.

17. An administering system according to claim 16, wherein said display device provides as said display view an operation control view used to control contents of display provided thereon,
and wherein said operating-information obtaining portion is operable to obtain the operating information relating to an operation on the basis of the display view which is provided on said display portion and which includes said operation control view, said operating information being correlated to said operation control view.

18. An administering system according to claim 17, wherein said display device is provided with an operation-contents indicating portion operable when said display view of said display device is controlled by said external-information-based operating portion, said operation-contents indicating portion indicating, within said display view, contents of an operation performed on the basis of said operating information.

19. An administering system according to claim 15, wherein said communication device is provided with a WWW server for delivering said display information of the display view provided on said display device, and said administering apparatus is provided with a browser for browsing said display information to be delivered by said WWW server.

20. A manufacturing system including at least one working device operable to perform a predetermined working operation on an object, which working operation is at least a portion of a process of manufacturing a desired product, said manufacturing system being administered by an administering apparatus existing at a location remote from the manufacturing system, and comprising:
a display device operable to provide a display view indicating at least a state of said working device; and
a communication device connected to said display device and provided with a display-information transmitting portion operable to transmit to said administering apparatus display information relating to said display view provided on said display device, such that a display view provided by said administering apparatus can include said display view provided on said display device.

21. A manufacturing system according to claim 20, wherein said communication device has an operating-information receiving portion operable to receive operating information relating to an operation performed on said administering apparatus to cause said administering apparatus to control the display view provided on said display device, and said display device is provided with an external-information-based operating portion operable to control its display view on the basis of said operating information received.

22. A manufacturing system according to claim 21, wherein said display device provides as said display view an operation control view used to control contents of display provided thereon,
and wherein said operating information is correlated to said operation control view.

23. A manufacturing system according to claim 22, wherein said display device is provided with an operation-contents indicating portion operable when said display view of said display device is controlled by said external-information-based operating portion, said operation-contents indicating portion indicating, within said display view, contents of an operation performed on the basis of said operating information.

24. A manufacturing system according to claim 20, wherein said communication device is provided with a WWW server for delivering said display information of the display view provided on said display device.

25. An administering apparatus for administering a manufacturing system, at a location remote from said manufacturing system, said manufacturing system including at least one working device operable to perform a predetermined working operation on an object, which working operation is at least a portion of a process of manufacturing a desired product, said manufacturing system further including a display device operable to provide a display view indicating at least a state of said working device, said administering apparatus comprising:
a communicating portion having a display-information receiving portion operable to receive display information relating to said display view provided on said display device, said communicating portion being operable to effect transmission and reception of information through a communication network; and
a display portion operable to provide a display view including said display view provided on said display device, on the basis of said display information received.

26. An administering apparatus according to claim 25, further comprising an operating-information obtaining portion operable to obtain operating information relating to an operation performed on said administering apparatus, and said communicating portion is provided with an operating-information transmitting portion operable to transmit said operating information.

27. An administering apparatus according to claim 26, wherein said display device provides as said display view an operation control view used to control contents of display provided thereon,
and wherein said operating-information obtaining portion is operable to obtain the operating information relating to an operation on the basis of the display view which is provided on said display portion and which includes said operation control view, said operating information being correlated to said operation control view.

28. An administering apparatus according to claim 27, wherein said operating information includes operation-contents information indicating contents of an operation of said administering apparatus to control the display view of said display device when said display view of said display device is controlled by said administering apparatus.

29. An administering apparatus according to claim 25, wherein said display information of said display view provided by said display device is delivered by a WWW server, said administering apparatus further comprising a WWW browser for browsing said display information to be delivered by said WWW server.
